(19) United States
(12) Patent Application Publication
(10) Pub. No.: US 2017/0310761 A1
(43) Pub. Date: Oct. 26, 2017

(54) FIRST TERMINAL APPARATUS, SERVER APPARATUS, AND CONTROL METHOD

(71) Applicant: SHARP KABUSHIKI KAISHA, Sakai City, Osaka (JP)

(72) Inventors: Masayuki ENOMOTO, Sakai City (JP); Masafumi ARAMOTO, Sakai City (JP)

(73) Assignee: SHARP KABUSHIKI KAISHA, Sakai City, Osaka (JP)

(21) Appl. No.: 15/516,315

(22) PCT Filed: Aug. 28, 2015
(86) PCT No.: PCT/JP2015/074459

§ 371 Date: Mar. 31, 2017

(30) Foreign Application Priority Data
Oct. 2, 2014 (JP) 2014-203821

(51) Int. Cl. H04L 29/08; H04W 4/10; H04W 12/06

(52) U.S. Cl. CPC H04L 67/14; H04W 4/10; H04W 12/06

(57) ABSTRACT

Provided is a communication control method of controlling transmission of audio data based on priority in a session for audio communications established between communication terminals. A server notifies a communication terminal of priority that can be used in a session for audio communications established between communication terminals, and a terminal apparatus notifies the server apparatus of priority when performing transmission, thus making it possible to control transmission of audio data based on the priority by UE 10.

### TECHNICAL FIELD

The present invention relates to a first terminal apparatus, a server apparatus, and a control method.

### BACKGROUND ART

The 3GPP (The 3rd Generation Partnership Project) of a group for standardizing mobile communication systems has been involved in specifying the EPS (Evolved Packet System) described in NPL 1 below as a next-generation mobile communication system and consideration has been gives to not only LTE (Long Term Evolution), but also Wireless LAN (WLAN) and WiMAX (Worldwide Interoperability for Microwave Access) as access systems connected to the EPS.

PTT (Push To Talk) is discussed in NPL 2. PIT is an arbitration system in which a server decides which terminal (UE, User Equipment) is to be permitted, at a certain time point, to perform transmission.

MCPTT (Mission Critical Push Talk) that is an extended technique of PIT has been considered in NPL 3. In MCPTT, a mechanism by which, when transmission having high priority occurs in PTT, the transmission having high priority is preferentially permitted has been considered.

### CITATION LIST

### Non Patent Literature

NPL 1: 3GPP TS23.402 General Technical Specification Group Services and System Aspects, Architecture enhancements for non-3GPP accesses

NPL 2: 3GPP TR 23.979 Technical Specification Group Services and System Aspects, 3GPP enablers for Open Mobile Alliance (OMA), Push-to-talk over Cellular (PoC) services, Stage2 (Release 11)

NPL 3: 3GPP TS 22.179 Technical Specification Group Services and Systems Aspects, Mission Critical Push to Talk MCPTT (Release 13)

### SUMMARY OF INVENTION

### Technical Problem

However, as the mechanism by which, when transmission having high priority occurs in a transmission request, UE preferentially permits the transmission having high priority, neither a method of acquiring priority nor a method of utilizing the acquired priority is clearly provided, such that it is difficult to transmit data in accordance with priority. It is difficult for the UE to acquire priority and hence it is difficult for the UE to perform transmission having high priority.

Even when the UE is able to acquire priority, it is difficult for the UE to perform transmission having high priority because it is unclear how the priority is to be utilized.

Since it is difficult for the UE to perform transmission having high priority, even when transmission not having high priority is performed, it is difficult to perform transmission having high priority until the transmission not having high priority is completed.

The invention has been made in view of such circumstances, and an object thereof is to provide, for example, a control method of performing data transmission and reception between terminals on the basis of an arbitration function in accordance with priority.

### Solution to Problem

In order to achieve the aforementioned object, the invention has taken the following measures. That is, the invention provides a first terminal apparatus which is configured to: transmit, to a second server apparatus, a service authentication request message of a communication service in which user data is transmitted or received on the basis of an arbitration function of a first server apparatus; where the arbitration function is a function for deciding which terminal apparatus of a plurality of terminal apparatuses is to be permitted, at a certain time point, to perform data transmission; receive, from the second server apparatus, a response message that is a response to the service authentication request message and includes at least information for permitting service authentication and priority; transmit, to the first server apparatus, a session establishment request message including at least the priority; receive, from the first server apparatus, a response message that is a response to the session establishment request message; establish, upon reception of the response message, a session of the communication service with a second terminal apparatus; receive, from the first server apparatus, user data transmitted by the second terminal apparatus that is permitted by the first server apparatus to perform data transmission for a certain fixed time; and transmit, to the first server apparatus, user data that is to be transmitted to the second terminal apparatus on the basis of the priority during the fixed time.

The first terminal apparatus transmits the service authentication message with at least the priority requested by the first terminal apparatus included therein.

A first terminal apparatus which is configured to: transmit a session establishment request message to a first server apparatus; receive, from the server apparatus, a response message that is a response to the session establishment request message, which includes at least priority; establish, upon reception of the response message, a session with a second terminal apparatus; where the session is a session in which user data is transmitted or received on the basis of an arbitration function of the first server apparatus; receive, from the first server apparatus, user data transmitted by the second terminal apparatus that is permitted by the first server apparatus to perform data transmission for a certain fixed time; and transmit, to the first server apparatus, user data that is to be transmitted to the second terminal apparatus on the basis of the priority during the fixed time.

The first terminal apparatus transmits the session establishment request message with at least the priority requested by the first terminal apparatus included therein.

The first terminal apparatus transmits a request message requesting the first server apparatus to transmit user data, receives a response message that is a response to the request message and that is transmitted by the first server apparatus, and transmits, to the first server apparatus, the user data that is to be transmitted to the second terminal apparatus on the basis of the response message.

The first terminal apparatus transmits the request message with at least the priority included therein.

A server apparatus which is configured to: receive, from a first terminal apparatus, a session establishment request message; transmit, to the first terminal apparatus, a response message that is a response to the session establishment request message, which includes at least priority; establish, upon transmission of the response message, a session of a communication service, in which user data is transmitted or received on the basis of an arbitration function, between the first terminal apparatus and a second terminal apparatus; where the arbitration function is a function for deciding which terminal apparatus of a plurality of terminal apparatuses is to be permitted, at a certain time point, to perform data transmission; permit the second terminal apparatus to perform data transmission for a fixed time on the basis of the arbitration function; receive user data transmitted by the second terminal apparatus on the basis of the permission; transmit the user data to the first terminal apparatus, receive user data transmitted by the first terminal apparatus on the basis of the priority during the fixed time; and transmit the user data to the second terminal apparatus.

A server apparatus which is configured to: receive, from a first terminal apparatus, a session establishment request message which includes at least the priority; transmit, to the first terminal apparatus, a response message that is a response to the session establishment request message; establish, upon transmission of the response message, a session of a communication service in which user data is transmitted or received on the basis of an arbitration function between the first terminal apparatus and a second terminal apparatus; where the arbitration function is a function for deciding which terminal apparatus of a plurality of terminal apparatuses is to be permitted, at a certain time point, to perform data transmission; permit the second terminal apparatus to perform data transmission for a fixed time on the basis of the arbitration function; receive user data transmitted by the second terminal apparatus on the basis of the permission; transmit the user data to the first terminal apparatus; receive user data transmitted by the first terminal apparatus on the basis of the priority during the fixed time; and transmit the user data to the second terminal apparatus.

The server apparatus receives, from the first terminal apparatus, a request message requesting transmission of user data, transmits, to the first terminal apparatus, a response message that is a response to the request message, and receive the user data transmitted by the first terminal apparatus on the basis of the response message.

The server apparatus receives the request message with at least the priority included therein, and receives the user data transmitted by the first terminal apparatus on the basis of the priority.

A control method of a first terminal apparatus includes the steps of: transmitting, to a second server apparatus, a service authentication request message of a communication service in which user data is transmitted or received on the basis of an arbitration function of a first server apparatus; where the arbitration function is a function for deciding which terminal apparatus of a plurality of terminal apparatuses is to be permitted, at a certain time point, to perform data transmission; receiving, from the second server apparatus, a response message that is a response to the service authentication request message and includes at least information for permitting service authentication and priority; transmitting, to the first server apparatus, a session establishment request message including at least the priority; receiving, from the first server apparatus, a response message that is a response to the session establishment request message; establishing, upon reception of the response message, a session of the communication service with a second terminal apparatus; receiving, from the first server apparatus, user data transmitted by the second terminal apparatus that is permitted by the first server apparatus to perform data transmission for a certain fixed time; and transmitting, to the first server apparatus, on the basis of the priority during the fixed time, user data which is to be transmitted to the second terminal apparatus.

The method includes the step of including at least the priority requested by the first terminal apparatus in the service authentication message.

A method includes the steps of: transmitting a session establishment request message to a first server apparatus; receiving, from the first server apparatus, a response message that is a response to the session establishment request message, which includes at least priority; establishing, upon reception of the response message, a session with a second terminal apparatus; where the session is a session in which user data is transmitted or received on the basis of an arbitration function of the first server apparatus; receiving, from the first server apparatus, user data transmitted by the second terminal apparatus that is permitted by the first server apparatus to perform data transmission for a certain fixed time; and transmitting to the first server apparatus, on the basis of the priority during the fixed time, user data which is to be transmitted to the second terminal apparatus.

The method includes the step of including at least the priority requested by the first terminal apparatus in the session establishment request message.

The method includes the steps of transmitting a request message requesting the first server apparatus to transmit user data; receiving a response message that is a response to the request message and that is transmitted by the first server apparatus; and transmitting, to the first server apparatus, on the basis of the response message, the user data which is to be transmitted to the second terminal apparatus.

The method includes the step of including at least the priority in the request message.

A control method of a server apparatus includes the steps of: receiving a session establishment request message from a first terminal apparatus; transmitting, to the first terminal apparatus, a response message that is a response to the session establishment request message, which includes at least priority; establishing, upon transmission of the response message, a session of a communication service, in which user data is transmitted or received on the basis of an arbitration function, between the first terminal apparatus and a second terminal apparatus; where the arbitration function is a function for deciding which terminal apparatus of a plurality of terminal apparatuses is to be permitted, at a certain time point, to perform data transmission; permitting, on the basis of the arbitration function, the second terminal apparatus to perform data transmission for a fixed time; receiving, on the basis of the permission, user data which is transmitted by the second terminal apparatus; transmitting the user data to the first terminal apparatus; receiving, on the basis of the priority during the fixed time, user data which is transmitted by the first terminal apparatus; and transmitting the user data to the second terminal apparatus.

A control method of a server apparatus includes the steps of: receiving, from a first terminal apparatus, a session establishment request message, which includes at least priority; transmitting, to the first terminal apparatus, a response message that is a response to the session establishment request message; establishing, upon transmission of the response message, a session of a communication service, in which user data is transmitted or received on the basis of an arbitration function, between the first terminal apparatus and a second terminal apparatus; where the arbitration function a function for deciding which terminal apparatus of a plurality of terminal apparatuses is to be permitted, at a certain time point, to perform data transmission; permitting, on the basis of the arbitration function, the second terminal apparatus to perform data transmission for a fixed time; receiving, on the basis of the permission, user data which is transmitted by the second terminal apparatus; transmitting the user data to the first terminal apparatus; receiving, on the basis of the priority during the fixed time, user data which is transmitted by the first terminal apparatus; and transmitting the user data to the first terminal apparatus.

The method includes the steps of: receiving, from the first terminal apparatus, a request message requesting transmission of user data; transmitting, to the first terminal apparatus, a response message that is a response to the request message; and receiving, on the basis of the response message, the user data which is transmitted by the first terminal apparatus.

The method includes the steps of: receiving the request message with at least the priority included therein and acquiring the priority, and executing, on the basis of the priority, reception of the user data that is transmitted by the first terminal apparatus.

### ADVANTAGEOUS EFFECTS OF INVENTION

According to the invention, priority that is able to be used for a session which is established between pieces of UE and in which audio communication is performed is provided to UE. Note that, by including priority at a time of data transmission, when transmission not having high priority is performed, the UE stops the transmission not have high priority and starts transmission having high priority.

### BRIEF DESCRIPTION OF DRAWINGS

FIG. 1 is a view for explaining the outline of a communication system in a first embodiment,

FIGS. 2(a) and (h) are views for explaining a configuration of an IP mobile communication network is the first embodiment.

FIG. 3 is a view for explaining a functional configuration of UE in the first embodiment.

FIG. 4 is a view for explaining a functional configuration of a service authentication server is the first embodiment.

FIG. 5 is a view for explaining a functional configuration of an MCPTT server in the first embodiment.

FIG. 6 is a view for explaining a flow of processing in the first embodiment.

FIG. 7 is a view for explaining a specific example of a service authentication procedure in the first embodiment.

FIG. 8A is a view for explaining a specific example of an on-demand session establishment procedure in the first embodiment.

FIG. 8B is a view for explaining a specific example of an on-demand session establishment procedure in the first embodiment.

FIG. 9 is a view for explaining a flow of processing in the first embodiment.

FIG. 10A is a view for explaining a specific example of a pre-established session establishment procedure in the first embodiment.

FIG. 10B is a view for explaining a specific example of a pre-established session establishment procedure in the first embodiment.

FIG. 11A is a view for explaining a specific example of a transmission request procedure in the first embodiment.

FIG. 11B is a view for explaining a specific example of a transmission request procedure in the first embodiment.

FIG. 12 is a view for explaining a flow of processing in a modified example 1.

FIG. 13A is a view for explaining an on-demand session establishment procedure in the modified example 1.

FIG. 13B is a view for explaining as on-demand session establishment procedure in the modified example 1.

FIG. 14 is a view for explaining a flow of processing in the modified example 1.

FIG. 15A is a view for explaining a pre-established session establishment procedure in the modified example 1.

FIG. 15B is a view for explaining a pre-established session establishment procedure in the modified example 1.

FIG. 16 is a view for explaining a flow of processing in a second embodiment.

FIG. 17A is a view for explaining a session establishment procedure in the second embodiment.

FIG. 17B is a view for explaining a session establishment procedure in the second embodiment.

FIG. 18 is a view for explaining a flow of processing in a modified example 2.

FIG. 19A is a view for explaining a session establishment procedure in the modified example 2.

FIG. 19B is a view for explaining a session establishment procedure in the modified example 2.

### DESCRIPTION OF EMBODIMENTS

The best mode for realizing the invention will be described below with reference to the drawings. Note that, in the present embodiment, a mobile communication system to which the invention is applied will be specifically described with reference to the drawings as an example of the embodiment. Note that, the invention is intended for a case where, in an arbitration system that decides which terminal is to be permitted, at a certain time point, to perform transmission, a session is established between terminals and audio communication is performed in the established session. Here, the session refers to a connection which is established between terminals and in which audio communication is able to be performed at fixed time intervals between the terminals.

### 1. First Embodiment

First, a first embodiment to which the invention is applied will be described with reference to the drawings.

### [1.1 Outline of Mobile Communication System]

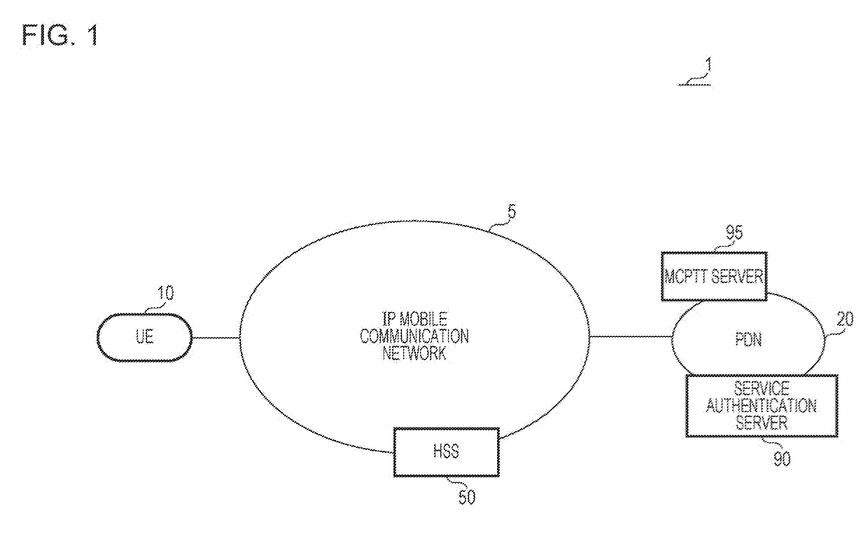

FIG. 1 is a view for explaining the outline of a communication system 1 in the present embodiment. As illustrated in this figure, the communication system is constituted by a UE (terminal apparatus) 10, an IP mobile communication network 5, and a PDN 20 (Packet Data Network).

The IP mobile communication network 5 may be, for example, a network formed of a radio access network, operated by a mobile communication provider, and a core network, or may be a broadband network operated by a fixed-line communication provider. Here, the broadband network may be an IP communication network operated by a communication provider, in which a connection is made through ADSL (Asymmetric Digital Subscriber Line) or the like and by which high-speed communication with the use of a digital line such as an optical fiber is provided. The broadband network is not limited thereto and may be a network in which radio access is provided with the use of WiMAX (Worldwide Interoperability for Microwave Access;) or the like.

The UE 10 is a terminal connected via LTE, WLAN, or WiMAX and is able to be connected to the IP mobile communication network 5 by a 3GPP LTE communication interface, a WLAN communication interface, a WiMAX communication interface, or the like loaded therein to enable the connection. Specific examples thereof include a mobile phone terminal and a smartphone, and further a tablet computer and a personal computer which have a communication function.

The PDN 20 is a network that provides a network service in which data is transmitted or received in packets and is, for example, the Internet or an IMS. Further, the PDN 20 may be a network that provides a group communication service such as a group call. The PDN 20 is connected to an IP access network by using a wired line or the like. The wired line is constituted by, for example, an ADSL (Asymmetric Digital Subscriber Line), an optical fiber, or the like. However, there is no limitation thereto, and a radio access network such as LTE (Long Term Evolution), WLAN (Wireless LAN), or WiMAX (Worldwide Interoperability for Microwave Access) may be used.

A service authentication server 90 and an MCPTT server 95 are arranged in the PDN 20. The service authentication server 90 is a server for authenticating that a transmission indicating priority is performed. The MCPTT server 95 is a server apparatus having an arbitration function for deciding which terminal is to be permitted, at a certain time point, to perform transmission. The arbitration function has a session management function and a floor control function. The session management function is a function for managing a connection which is established between terminals and in which audio data is able to be performed at fixed time intervals between the terminals. The floor control function is a function for controlling the decision about which terminal is to be permitted, at a certain time point, to perform transmission.

The service authentication server 90 may be configured to be included in the PDN 20, included in the IP mobile communication network 5 separately from the PDN 20, or included in a core network 7.

### [1.1.2 Configuration Example of IP Mobile Communication Network]

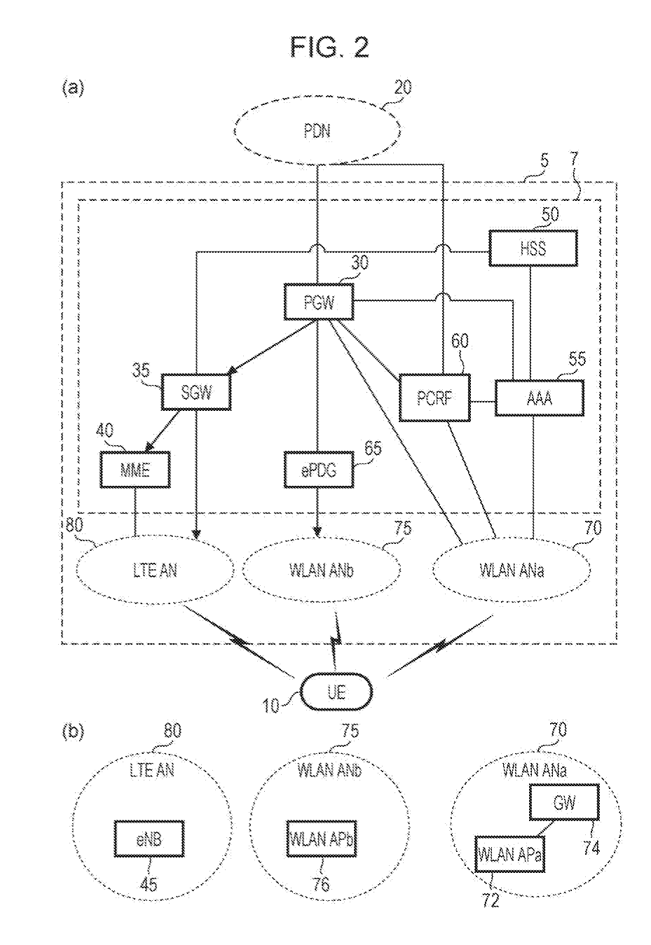

A plurality of pieces of UE in addition to the UE 10 are able to be connected to the IP mobile communication network 5, but description thereof is omitted to simplify the drawing. Further, the IP mobile communication network 5 is constituted by the core network 7 and radio access networks. A detailed configuration of the core network 7 is illustrated in FIG. 2(a).

Note that, the PDN 20 is a network that provides a network service described with the use of FIG. 1 in which data is transmitted or received in packets and is, for example, the Internet or an IMS.

The core network 7 includes a PGW (access control apparatus) 30 (Packet Data Network Gateway), an SGW 35 (Serving Gateway), an MME 40 (Mobile Management Entity), an HSS 50 (Home Subscriber Server), an AAA 55 (Authentication, Authorization, Accounting), a PCRF 60 (Policy and charging rules function), and an ePDG 65 (enhanced Packet Data Gateway).

A radio access network may be constituted by a plurality of different access networks. Each of the access networks is connected to the core network 7. Further, the UE 10 is able to connect wirelessly with the radio access network.

The radio access network is able to form an LTE access network (LTE AN 80) connectable via an LTE access system and as access network connectable via a WLAN access system.

Further, the access network connectable by the WLAN access system is able to form a WLAN access network b (WLAN ANb 75) to which a connection is made via the ePDG 65 as a connection apparatus for the core network 7, and a WLAN access network a (WLAN ANa 70) connected to the PGW 30, the PCRF 60, and the AAA 55.

Note that, each of the apparatuses has a similar configuration to that of a conventional apparatus is a mobile communication system utilizing an EPS, and thus detailed description thereof will be omitted. To provide a brief description of functions, the PGW 30 is connected to the PDN 20, the SGW 35, the ePDG 65, the WLAN ANa, the PCRF 60, and the AAA 55 and is a gateway apparatus for the PDN 20 and the core network 7 to transfer user data.

The SGW 35 is connected to the PGW 30, the MME 10, and the LTE AN 80 and is a gateway apparatus for the core network 7 and the LTE AN 80 to transfer user data.

The MME 40 is connected to the SGW 35 and the LTE AN 80 and is an access control apparatus for performing access control of the UE 10 via the LTE AN 80.

The HSS 50 is connected to the SGW 35 and the AAA 55 and manages subscriber information. The AAA 55 is connected to the PGW 30, the HSS 50, the PCRF 60, and the WLAN ANa 70 and performs access control of the UE 10 connected via the WLAN ANa 70. The PCRF 60 is connected to the PGW 30, the WLAN ANa 70, and the ASIA 55 and performs QoS management for data transfer.

The ePDG 65 is connected to the PGW 30 and the WLAN ANb 75 and is a gateway apparatus for the core network 7 and the WLAN ANb 75 to transfer user data.

As illustrated in FIG. 2(b), each of the radio access networks includes an apparatus (for example, a base station apparatus or an access point apparatus) or the like, to which the UE 10 is actually connected. Various apparatuses adapted to a radio access network may be used as an apparatus for a connection, but in the present embodiment, the LTE AN 80 includes an eNB 45. The eNB 45 is a radio base station to which the UE 10 is connected via an LTE access system, and the LTE AN 80 may include one or more radio base stations.

Further, the WLAN ANa 70 includes a WLAN APa 72 and a GU 74 (Gateway). The WLAN AP 72 is a radio base station to which the UE 10 is connected via a WLAN access system, and the WLAN AN 70 may include one or more radio base stations. The GW 74 is a gateway apparatus for the core network 7 and the WLAN ANa 70. The WLAN APa 72 and the GW 74 may constitute a single apparatus.

In this manner, the gateway included in the WLAN ANa 70 is able to be connected to a plurality of apparatuses in the core network 7. For example, when a communication provider operating the core network 7 is different from a communication provider operating the WLAN ANa 70, operation with such a configuration is able to be performed in a case where the communication providers have a relationship of trust with each other on the basis of a contract, a rule, or the like concerning the operation. In other words, the WLAN APa 72 is an access network that is reliable for the communication provider operating the core network 7.

The WLAN ANb 75 includes a WLAN APb 76. The WLAN AP 76 is a radio base station to which the UE 10 is connected via a WLAN access system, and the WLAN AN 75 may include one or more radio base stations.

In this manner, the WLAN ANb 75 is connected to the core network 7 by using the ePDG 65, which is an apparatus included in the core network 7, as a gateway. The ePDG 65 has a security function for ensuring security. For example, when the communication provider operating the core network 7 is different from the communication provider operating the WLAN ANa 70, operation with such a configuration is performed in a case where the communication providers do not have a relationship of trust with each other on the basis of a contract, a rule, or the like concerning the operation. In other words, the WLAN APa is an access network that is not reliable for the communication provider operating the core network 7 and provides security in the ePDG 65 included in the core network 7.

Note that, in this specification, a state in which the UE 10 is connected to a radio access network corresponds to a state in which the UE 10 is connected to a base station apparatus, an access point, or the like, which is included in the radio access network, and transmission or reception of data, a signal, and the like is also via the base station apparatus or the access point.

For example, a state where the UE 10 is connected to the LTE AN 80 corresponds to a state where the UE 10 is connected thereto via the eNB 45, and a state where the UE 10 is connected to the WLAN ANa 70 corresponds to a state where the UE 10 is connected thereto via the WLAN APa 72 and/or the GW 74. A state where the UE 10 is connected to the WLAN ANb 75 corresponds to a state where the UE 10 is connected to the WLAN APb 76.

[1.2 Apparatus configuration]

Next, configurations of the respective apparatuses will be briefly described with the use of the drawings.

### [1.2.1 Configuration of UE]

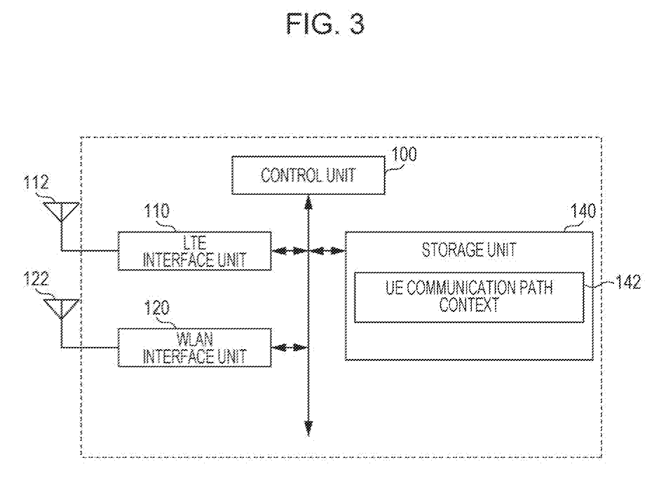

FIG. 3 illustrates a configuration of the UE 10 in the present embodiment. In the UE 10, an LTE interface unit 110, a WLAN interface unit 120, and a storage unit 140 are connected to a control unit 100 via a bus.

The control unit 100 is a functional unit for controlling the UE 10. The control unit 100 reads and executes various programs stored in the storage unit 140 and thereby implements various processing.

The LTE interface unit 110 is a functional unit that is used for the UE 10 to be connected to an LTE base station and connected to the IP access network. An external antenna 112 is connected to the LTE interface unit 110.

The WLAN interface unit 120 is a functional unit that is used for the UE 10 to be connected to a WLAN access point and connected to the IP access network. An external antenna 122 is connected to the WLAN interface unit 120.

The storage unit 140 is a functional unit in which programs, data, and the like that are desired for various operations of the UE 10 are stored. Further, a UE communication path context 142 is stored in the storage unit 140. The UE communication path context 142 is an information group that is stored in association with a communication path established by the UE and has, for example, information about an APN (access point name), a bearer ID, an IP address, and a QoS (Quality of Service) managed.

In the UE communication path context 142, information about priority is managed. In this case, the information about priority may include information about priority notified from the service authentication server 90. Note that, the information about priority managed in this case is included in a transmission request transmitted when the UE 10 transmits data. Here, from the information about priority notified from the service authentication server 90, any information about priority to be included in the transmission request may be selected by the UE 10 or a user of the UE 10 is accordance with urgency of data.

For example, in a case where the UE 10 is notified from the service authentication server 90 of Highest as the information about priority, the UE 10 may select, as priority, Highest, High, Normal, Low, or Lowest from the information about priority in accordance with urgency of data. In a case where the UE 10 is notified of Normal as the information about priority notified from the service authentication server 90, the UE 10 may select, as priority, Normal, Low, or Lowest from the information about priority in accordance with urgency of data. In this manner, the UE 10 may select the priority with the information about priority notified from the service authentication server 90 as an upper limit.

Though the priority is represented by five levels of Lowest to Highest here, but does not need to have the five levels and may have ten levels or twenty levels.

In the UE communication path context 142, a UE identifier may be managed. The UE identifier is information for identifying UE. The UE identifier may be IMSI (International Mobile Subscriber Identity), IMEI (International Mobile Equipment Identity)/IMEISV (International Mobile Equipment Identity Software Version), or the like. The IMSI refers to an identification number assigned by a mobile communication provider to a contractor. The IMEI/IMEISV refers to an identification number specific to a terminal, which is assigned at a time of manufacturing the terminal.

The UE 10 may manage a talker ID. The talker ID is a UE identifier of the UE 10, which is able to be used for a session establishment procedure and a transmission request procedure.

The UE 10 may notify the service authentication server 90 of the UE identifier in a service authentication procedure.

Further, the UE 10 may manage a talker ID alias. The talker ID alias is a UE identifier associated with a talker ID in a one-to-one manner. As the UE identifier notified to the MCPTT server 95 in the session establishment procedure and the transmission request procedure, not the IMSI or talker ID but the talker ID alias may be notified. The UE 10 may manage the talker ID alias by receiving it from the service authentication server 90.

In the UE communication path context 142, information for identifying a group may be managed. In the information for identifying a group, information for identifying a group to which the UE 10 belongs is managed. The UE 10 may manage a group identifier as the information for identifying a group.

The UE 10 may manage a group identifier alias. The group identifier alias is information for identifying a group associated with a group identifier in a one-to-one manner. The group identifier alias may be information for identifying a group assigned from a group identifier. The UE 10 may not perform the session establishment, procedure or the transmission request procedure by using a group identifier uniquely assigned to each UE, but may perform the session establishment procedure and the transmission request procedure by using a group identifier alias. The group identifier alias may be assigned from the service authentication server 90.

The UE 10 may establish a session, in which only UE in the same group is able to participate, by notifying the MCPTT server 95 of the information for identifying a group in the session establishment procedure. Moreover, the UE 10 may transmit data only to UE, which belongs to the same group, by notifying the MCPTT server 95 of the information for identifying a group in the transmission request procedure.

In the UE communication path context 142, information for identifying a UE type may be managed. The information for identifying a UE type includes category information indicating normal, a manager, an operation manager, or the like. Note that, the information for identifying a UE type may be notified and managed at a time of service authentication. The information for identifying a UE type may be set by user setting.

### [1.2.2 Configuration Example of Service Authentication Server]

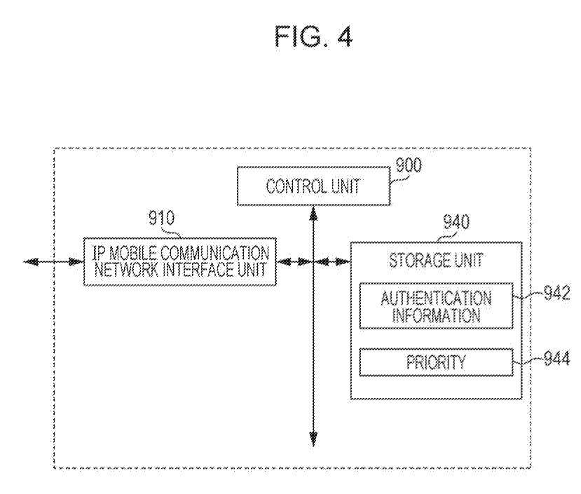

FIG. 4 illustrates a configuration of the service authentication server 90 in the present embodiment. In the service authentication server 90, an IF mobile communication network interface unit 910 and a storage unit 940 are connected to a control unit 900 via a bus.

The control unit 900 is a functional unit for controlling the service authentication server 90. The control unit 900 reads and executes various programs stored in the storage unit 940 and thereby implements various processing.

The IP mobile communication network interface unit 910 is a functional unit that is used for the service authentication server 90 to be connected to an IP mobile communication network.

The storage unit 940 is a functional unit in which programs, data, and the like that are desired for various operations of the service authentication server 90 are stored. Further, authentication information 942 and priority 944 are stored in the storage unit 940.

The authentication information 942 includes information for authenticating that audio communication is able to be performed at fixed time intervals between pieces of UE in a connection established between terminals. For example, the authentication information 942 may include a UE identifier for which authentication is permitted.

The UE identifier may be a talker ID. The service authentication server 90 may manage a talker ID alias. In this case, the service authentication server 90 may assign the talker ID alias from the talker ID.

Upon reception of a service authentication request from the UE 10, the service authentication server 90 may transmit the service authentication request to the HSS 50, receive, from the HSS, a response to the service authentication request and thereby authenticate the UE 10. The service authentication server 90 may receive a talker ID from the HSS 50.

The service authentication server 90 may include a group identifier in the authentication information 942. In this case, the service authentication server 90 may assign a group identifier alias from the group identifier and manage the group identifier alias.

In the priority 944, information about priority that is able to be used by the UE 10 is managed. In the priority 944, priority that is able to be used by the UE 10 may be managed by performing management so that the UE 10 and priority are associated with each other. The service authentication server 90 may transmit the service authentication request to the HSS 50, receive a response to the service authentication request, and thereby detect the priority that is able to be used by the UE 10.

The service authentication server 90 having detected the priority that is able to be used by the UE 10 transmits the priority to the UE 10 by including the priority in the response to the service authentication request.

### [1.2.3 Configuration Example of MCPTT Server]

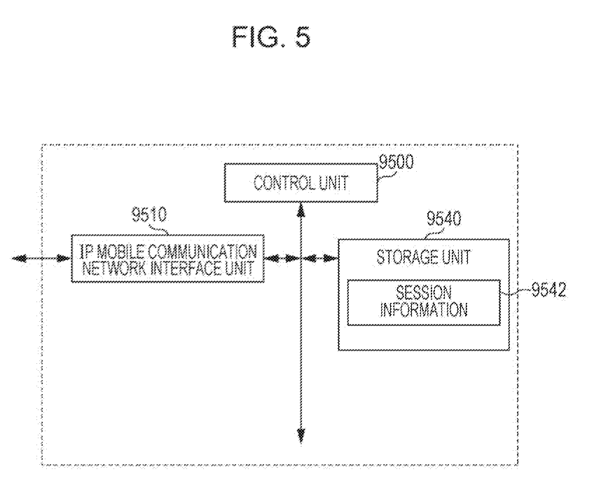

FIG. 5 illustrates a configuration of the MCPTT server 95 in the present embodiment. In the MCPTT server 95, an IP mobile communication network interface unit 9510 and a storage unit 9540 are connected to a control unit 9500 via a bus.

The control unit 9500 is a function for controlling the MCPTT server 95. The control unit 9500 reads and executes various programs stored in the storage unit 9540, and thereby implements various processing.

The IP mobile communication network interface unit 9510 is a functional unit that is used for the MCPTT server 95 to be connected to an IP mobile communication network.

The storage unit 9540 is a functional unit in which programs, data, and the like that are desired for various operations of the MCPTT server 95 are stored. Further, session information 9542 is stored in the storage unit 9540.

The session information 9542 may include, for example, identification information for identifying a session. The session refers to a connection which is established between terminals and in which the UE 10 is able to perform audio data at fixed time intervals between pieces of UE. When having received a session establishment request, the MCPTT server 95 may secure a session is which audio data is able to be performed at fixed time intervals between pieces of UE, newly assign a session identifier, and notify the UE 10 of the newly assigned session identifier.

In the session information 9542, the MCPTT server 95 may manage information about UE using the session. In the session information 9542, the MCPTT server 95 may manage information about UE performing transmission and priority.

Note that, when having newly received a transmission request from the UE 10 while different UE is performing transmission, the MCPTT server 95 may interrupt the transmission and permit the newly received transmission request to start transmission of the UE 10. In this case, the MCPTT server 95 may compare priority associated with the session to priority included in the transmission request, and thereby interrupt the transmission of the different UE and permit the new transmission request from the UE 10 to start transmission of the UE 10.

Note that, when having determined that the priority included in the transmission request is not higher than the priority associated with the session, the MCPTT server 95 may cause the UE 10 to wait to perform transmission or reject the transmission of the UE 10.

The MCPTT server 95 may manage a UE identifier of the In this case, the MCPTT server 95 may manage a talker ID of the UE 10 as the UE identifier. The MCPTT server 95 may manage a talker ID alias associated with the talker ID of the UE 10 in a one-to-one manner.

Further, the MCPTT server 95 may manage information for identifying a group. The MCPTT server 95 may manage a group identifier as the information for identifying a group. The MCPTT server 95 may manage a group identifier alias associated with the group identifier in a one-to-one manner.

### [1.3 Description of Processing]

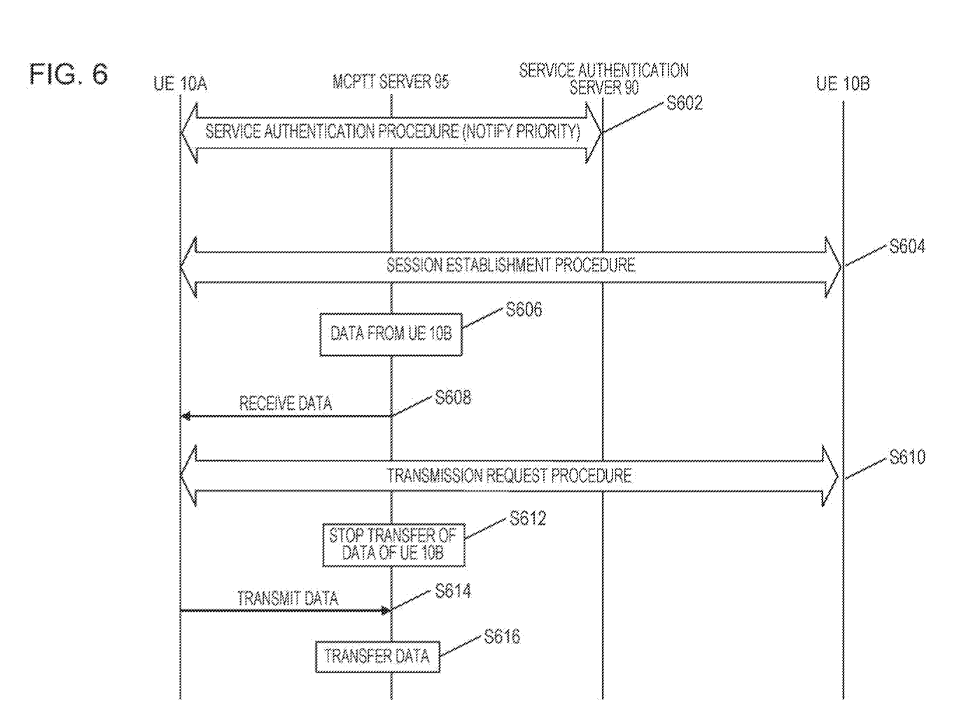

A flow of processing in the present embodiment will be described with the use of FIG. 6. Rote that, the description will be given by assuming that UE 10A performs data transmission to UE 10B.

First, the UE 10A performs a service authentication procedure with the service authentication server 90 (S602). Note that, in the present embodiment, priority is notified to the UE 10A by the service authentication procedure. Here, the service authentication procedure is performed also in the UE 10B similarly to the UE 10A.

Next, the UE 10A performs a session establishment procedure with the UE 10B (S604). With the session establishment procedure, the UE 10A and the UE 10B are able to establish a connection between pieces of the UE, in which audio data is able to be transmitted at fixed time intervals between pieces of the UE. The UE 10A is able to receive the audio data in the established session. When the UE 10A performs transmission, the transmission is able to be started by a transmission request procedure.

Then, in the established session, the MCPTT server 95 receives the audio data from the UE 10B which is different from the UE 10A (S606). The MCPTT server 95 transfers, to the UE 10A, the data transmitted from the UE 10B. Thereby, the UE 10A receives the data from the UE 10B (S608).

Note that, similarly to the UE 102, the UE 10B also performs the service authentication procedure (S602), the session establishment procedure (S604), the transmission request procedure (S610), and then transmits audio data to the MCPTT server 95. From the MCPTT server 95, the UE 10A receives the audio data from the UE 10B (S608).

In the present embodiment, while the UE 10B is performing transmission, transmission of data having high priority occurs in the UE 10A. The UE 10A in which transmission of data having high priority occurs performs a transmission request procedure (S610). Note that, the UE 10A notifies the MCPTT server 95 of priority in the transmission request procedure. In this case, the MCPTT server 95 sets a time for the transmission of the UE 10B, and during the time that is set, the UE 10A causes transmission having high priority and performs a transmission request procedure.

The MCPTT server 95 detects the priority, compares the priority to priority associated with the audio data being transmitted, and decides to stop the audio data of the UE 10B (S612).

On the other hand, the UE 10A in which the transmission request procedure is completed transmits the audio data to the MCPTT server 95 (S614). The MCPTT server 95 transfers, to the UE 10B, the audio data received from the UE 10A (S616).

With the aforementioned procedures, audio data having high priority is able to be preferentially transmitted on the basis of priority. That is, the MCPTT server 95 is able to interrupt the audio data being transmitted and transmit the audio data having high priority.

### [1.3.1 Service Authentication Procedure]

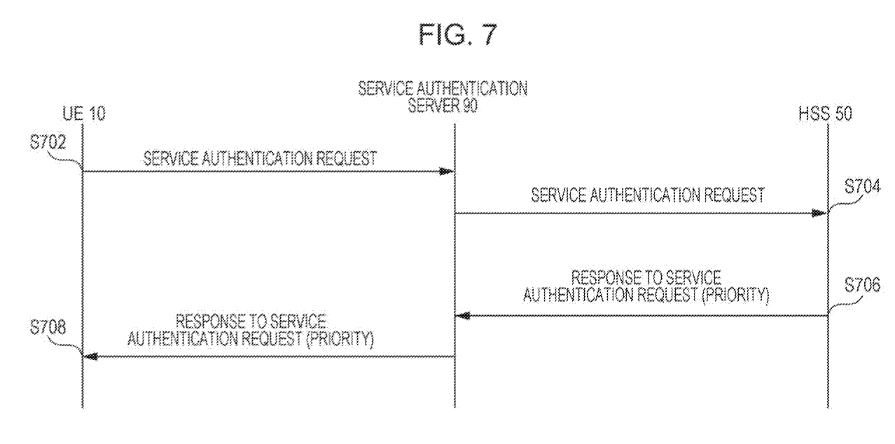

A specific example of the service authentication procedure will be described with the use of FIG. 7. First, the UE 10 transmits a service authentication request to the service authentication server 90 (S702). In this case, the UE 10 may include information about priority therein. Here, the information about priority, which is included therein by the UE 10, may be information about priority, which is requested by the UE 10.

The UE 10 may include a UE identifier of the UE 10. In this case, a UE identifier 1 may be IMSI or IMEI/IMEISV managed by a mobile communication provider (HSS 50). A UE identifier 2 may be a talker ID. The UE 10 may include a group identifier.

The service authentication server 90 receives the service authentication request from the UE 10. The service authentication server 90 may receive the service authentication request, and thereby detect the information about priority, the UE identifier 1, the UE identifier 2, or the group identifier.

Further, the service authentication server 90 transmits a service authentication request to the HSS 50 (S704). The service authentication request may include the information about priority and the UE identifier 1 which are included in the service authentication request (S702) from the UE 10.

The HSS 50 receives the service authentication request from the MCPTT server 95. By receiving the service authentication request, the HSS 50 may detect the information about priority and the UE identifier 1. The HSS 50 authenticates the UE 10 by the UE identifier 1.

The HSS 50 further detects information about priority that is able to be used by the UE 10. For example, with the use of the UE identifier 1, the HSS 50 may detect the information about priority that is able to be used by the UE 10. The HSS 50 may manage, in advance, the UE identifier 1 and the information about usable priority and detect information about usable priority, which corresponds to the UE identifier 1.

When the service authentication request includes information about priority, the HSS 50 may authenticate the information about priority from the UE 10. In this case, when the detected information about usable priority has higher priority than or the same priority as that of the information about priority notified from the UE 10, the HSS 50 may authenticate the priority notified from the UE 10.

Further, the HSS 50 may detect information for identifying a OP type. The HSS 50 may manage, in advance, the UE identifier 1 and information for identifying a OP type and detect information for identifying a UE type, which corresponds to the UE identifier 1.

The HSS 50 having authenticated the UE 10 and detected the information about priority transmits, to the service authentication server 90, a response to the service authentication request (S706). In this case, the HSS 50 includes information about authentication and the information about priority in the response to the service authentication request. The information about authentication may be the UE identifier 1 of the UE 10 or information for identifying a UE type. The information about priority may include the detected information about usable priority. When the priority notified from the UE 10 is authenticated, the notified priority may be included.

The service authentication server 90 receives, from the HSS 50, the response to the service authentication request. The service authentication server 90 detects the information about authentication and the information about priority which are included in the response to the service authentication request. In this case, the service authentication server 90 may manage the information about authentication and the information about priority.

The service authentication server 90 may assign a UE identifier 3, which is different from the UE identifier or the UE identifier 2, to the UE 10A. The service authentication server 90 may manage the UE identifier 3 as the information about authentication.

The service authentication server 90 may assign a group identifier 2 different from a group identifier 1. The service authentication server 90 may manage the group identifier 2 as the information about authentication.

The service authentication server 90 transmits, to the UE 10, a response to the service authentication request (S708). In this case, the service authentication server 90 includes the information about authentication and the information about priority in the response to the service authentication request.

The UE 10 receives, from the service authentication. server 90, the response to the service authentication request. The UE 10 detects the information about authentication and the information about priority which are included in the response to the service authentication request in this case, the UE 10 may manage the information about authentication and the information about priority.

With the aforementioned procedure, the service authentication procedure is able to be completed. With the service authentication procedure, the UE 10 is able to receive the information about authentication and the information about priority from the service authentication server 90 and perform the session establishment procedure.

The UE 10 may detect the UE identifier 1, the UE identifier 2, and the UE identifier 3 by receiving the information about authentication. Though a UE identifier is used to indicate the UE 10 in the subsequent procedure, any of the UE identifier 1, the UE identifier 2, and the UE identifier 3 may be used as long as indicating the UE 10.

The UE 10 may detect the group identifier 1 and the group identifier 2 by receiving the information about authentication. Though a group identifier is used to indicate a group in the subsequent procedure, any of the group identifier 1 and the group identifier 2 may be used as long as indicating a group.

The service authentication procedure performed by the UE 10 may be performed by the UE 10A or may be performed by the UE 10B.

### [1.3.2 Session Establishment Procedure]

A specific example of the session establishment procedure will be described. The session establishment procedure has an on-demand session establishment procedure and a pre-established session establishment procedure. The on-demand session is a session that is established, when the UE 10A transmits data, between the UE 10A and the UE 10B which serves as a communication target. The pre-established session is a session that is established in advance, for example, in group communication.

In the on-demand session establishment procedure, the UE 10A performing the session establishment transmits a request of the session establishment to the UE 10B serving as the communication target and causes the UE serving as the communication target to establish the session. In the on-demand session establishment procedure, the UE 10A is able to check that the session establishment is able to be performed with the UE 10B serving as the communication target.

On the other hand, in the pre-established session establishment procedure, the UE 10A only transmits a request of the session establishment to a group to establish the session and does not transmit the request of the session establishment to the UE 10B serving as the communication target. In the pre-established session establishment procedure, even when there are many users participating in the group, the session is able to be established without increasing signaling.

### [3.2.1 On-Demand Session Establishment Procedure]

First, the on-demand session establishment procedure will be described. In the on-demand session establishment procedure, in the UE 10A and the UE 10B in each of which the service authentication procedure is completed, the session establishment procedure in which the UE 10A requests session establishment to the UE 10B is performed. The MCPTT server 95 managing the session of the UE 10A is set as an MCPTT server 95A and the MCPTT server 95 managing the session of the UE 10B is set as an MCPTT server 95B. As a specific example of the on-demand session establishment procedure, an on-demand session establishment procedure 1 and an on-demand session establishment procedure 2 will be described.

### [1.3.2.1.1 On-Demand Session Establishment Procedure 1]

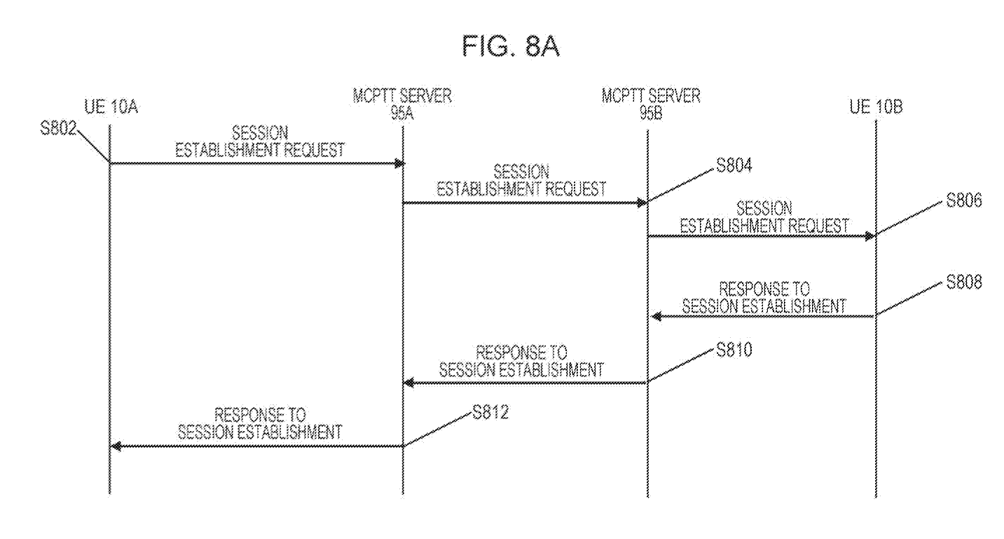

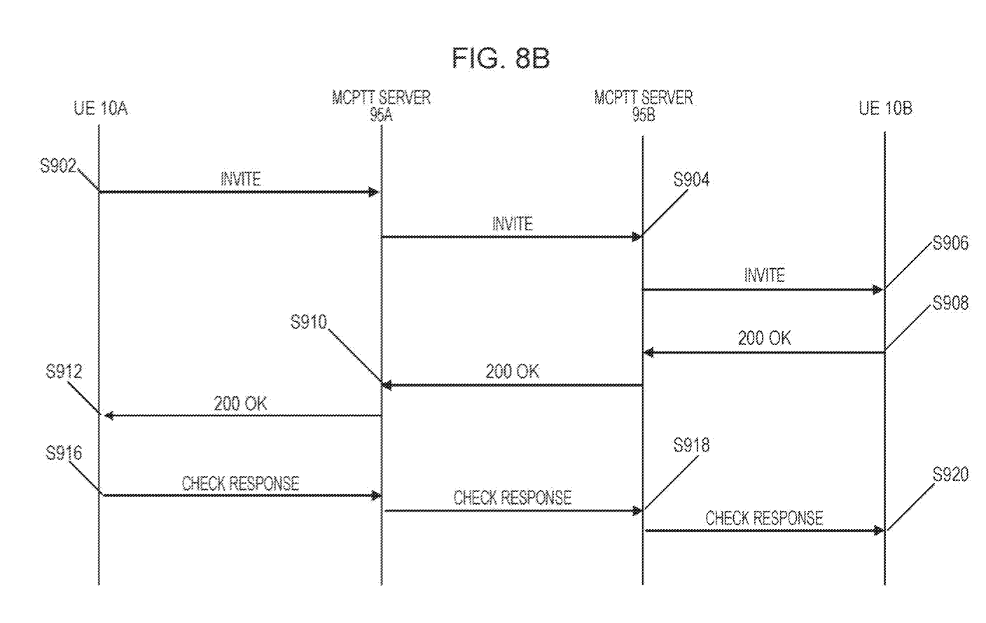

The on-demand session establishment procedure 1 will be described with the use of FIG. 8A. First, the UE 10A transmits a session establishment request to the MCPTT server 95A (S802). Note that, the UE 10A includes a UE identifier of the UE 10A and a UE identifier of the UE 10B in the session establishment request.

The MCPTT server 95A receives the session establishment request. The MCPTT server 95A having received the session establishment request detects the UE identifier of the UE 10A and the UE identifier of the UE 10B which are included in the session establishment request. In this case, because of managing the UE identifier of the UE 10A, the MCPTT server 95A permits the UE 10A to establish the session. The MCPTT server 95A permits the session establishment, and thereby newly assigns a session identifier for managing the session. On the other hand, because of not managing the UE identifier of the UE 10B, the MCPTT server 95A detects that the session of the UE 10B is managed by another MCPTT server 95.

Next, the MCPTT server 95A transmits a session establishment request to the MCPTT server 95B that manages the session of the UE 10B (S804). The MCPTT server 95A includes the UE identifier of the UE 10A, the UE identifier of the UE 10B, and the session identifier in the session establishment request. In this case, the MCPTT server 95A may detect the MCPTT server 95B that manages the session of the UE 10B and transmit the session establishment request to the MCPTT server 95B.

The MCPTT server 95A may perform management by associating the MCPTT server 95B and the UE 10B in advance, and thereby detect that the session of the UE 10B is managed by the MCPTT server 95B.

The MCPTT server 95A may query MCPTT servers 95 by using the UE identifier of the UE 10B in order to detect an MCPTT server 95 that manages the session of the UE 10B, and detect an MCPTT server 95, from which an acknowledgement response is provided, as the MCPTT server 95B that manages the session of the UE 10B.

Note that, a method of detecting the MCPTT server 95B, which manages the session of the UE 10B, by the MCPTT server 95A may be any method as long as the MCPTT server 95B is able to be detected.

The MCPTT server 95B receives the session establishment request. The MCPTT server 95B detects the UE identifier of the UE 10A, the UE identifier of the UE 10B, and the session identifier which are included in the session establishment request. In this case, because of managing the UE identifier of the UE 10B, the MCPTT server 95B permits the UE 10B to establish the session.

The MCPTT server 95B transmits a session establishment request to the UE 10B (S806). The MCPTT server 95B includes the UE identifier of the UE 10A and the session identifier in the session establishment request.

The UE 10B receives the session establishment request. The UE 10B detects the UE identifier of the UE 10A and the session identifier which are included in the session establishment request. The UE 10B permits the session establishment with the UE 10A and manages the UE identifier of the UE 10A and the session identifier.

The UE 10B transmits, to the MCPTT server 95B, a response to the session establishment request (S808). The UE 10B may include the UE identifier of the UE 10A, the UE identifier of the UE 10B, and the session identifier in the response to the session establishment request.

The MCPTT server 95B receives, from the UE 10B, the response to the session establishment request. Upon reception of the response to the session establishment request, the MCPTT server 95B detects that the UE 10B has permitted the session establishment with the UE 10A. In this case, the MCPTT server 95B may manage the session identifier, the UE identifier of the UE 10A, and the UE identifier of the UE 10B.

The MCPTT server 95B transmits, to the MCPTT server 95A, a response to the session establishment request (S810). The MCPTT server 95B may include the UE identifier of the UE 10A, the UE identifier of the UE 10B, and the session identifier in the response to the session establishment request.

The MCPTT server 95A receives the response to the session establishment request. Upon reception of the response to the session establishment request, the MCPTT server 95A detects that the MCPTT server 95B and the UE 10B have permitted the session establishment with the UE 10A. In this case, the MCPTT server 95A may manage the session identifier, the UE identifier of the UE 10A, and the UE identifier of the UE 10B.

The MCPTT server 95A transmits, to the UE 10A, a response to the session establishment request (S812). The MCPTT server 95A may include the UE identifier of the UE 10A, the UE identifier of the UE 10B, and the session identifier in the response to the session establishment request.

The UE 10A receives the response to the session establishment request. The UE 10A may detect the session identifier, the UE identifier of the UE 10A, and the UE identifier of the UE 10B, and manage the session identifier, the UE identifier of the UE 10A, and the UE identifier of the UE 10B.

With the aforementioned procedure, the UE 10A is able to establish the session with the UE 10B.

### [1.3.2.1.2 On-Demand Session Establishment Procedure 2]

Next, the on-demand session establishment procedure 2 will be described with the use of FIG. 8B. In the on-demand session establishment procedure 2, a session establishment procedure is performed by using a message in an SIP (Session Initiation Protocol) which is a session establishment protocol.

First, the UE 10A transmits an invite message to the MCPTT server 95A (S902). Not that, the UE 10A includes the UE identifier of the UE 10A and the UE identifier of the UE 10B in the invite message.

The MCPTT server 95A receives the invite message. The MCPTT server 95A having received the invite message detects the UE identifier of the UE 10A and the UE identifier of the UE 10B which are included in the invite message. In this case, because of managing the UE identifier of the UE 10A, the MCPTT server 95A permits the UE 10A to establish the session. By permitting the session establishment, the MCPTT server 95A newly assigns a session identifier for managing the session. On the other hand, because of not managing the UE identifier of the UE 10B, the MCPTT server 95A detects that the session of the UE 10B is managed by another MCPTT server 95.

The MCPTT server 95A then transmits an invite message to the MCPTT server 95B that manages the session of the UE 10B (S904). The MCPTT server 95A includes the UE identifier of the UE 10A, the UE identifier of the UE 10B, and the session identifier in the invite message. In this case, the MCPTT server 95A may detect the MCPTT server 95B that manages the session of the UE 10B and transmit the invite message to the MCPTT server 95B.

Note that, a method of detecting the MCPTT server 95B, which manages the session of the UE 10B, by the MCPTT server 95A has been described in the on-demand session establishment procedure 1, so that detailed description thereof will be omitted.

The MCPTT server 95B receives the invite message. The MCPTT server 95B detects the UE identifier of the UE 10A, the UE identifier of the UE 10B, and the session identifier which are included in the invite message in this case, because of managing the UE identifier of the UE 10B, the MCPTT server 95B permits the UE 10B to establish the session.

The MCPTT server 95B transmits an invite message to the UE 10B (S906). The MCPTT server 95B includes the UE identifier of the UE 10A and the session identifier in the invite message.

The UE 10B receives the invite message. The UE 10B detects the UE identifier of the UE 10A and the session identifier which are included in the invite message. The UE 10B permits the session establishment with the UE 10A and manages the UE identifier of the UE 10A and the session identifier.

The UE 10B transmits a 200 OK message to the MCPTT server 95B (S908). The UE 10B may include the UE identifier of the UE 10A, the UE identifier of the UE 10B, and the session identifier in the 200 OK message.

The MCPTT server 95B receives the 200 OK message from the UE 10B. Upon reception of the 200 OK message, the MCPTT server 95B detects that the UE 10B has permitted the session establishment with the UE 10A. In this case, the MCPTT server 95B may manage the session identifier, the UE identifier of the UE 10A, and the UE identifier of the UE 10B.

The MCPTT server 95B transmits a 200 OK message to the MCPTT server 95A (S910). The MCPTT server 95B may include the UE identifier of the UE 10A, the UE identifier of the UE 10B, and the session identifier in the 200 OK message.

The MCPTT server 95A receives the 200 OK message. Upon reception of the 200 OK message, the MCPTT server 95A detects that the MCPTT server 95B and the UE 10B have permitted the session establishment with the UE 10A. In this case, the MCPTT server 95B may manage the session identifier, the UE identifier of the UE 10A, and the UE identifier of the UE 10B.

The MCPTT server 95A transmits a 200 OK message to the UE 10A (S912). The MCPTT server 95A may include the UE identifier of the UE 10A, the UE identifier of the UE 10B, and the session identifier in the 200 OK message.

The UE 10A receives a response to a session establishment request. The UE 10A may detect the session identifier, the UE identifier of the UE 10A, and the UE identifier of the UE 10B, and manage the session identifier, the UE identifier of the UE 10A, and the UE identifier of the UE 10B.

With the aforementioned procedure, the UE 10A is able to establish the session with the UE 10B.

### [1.3.2.2 Pre-Established Session Establishment Procedure]

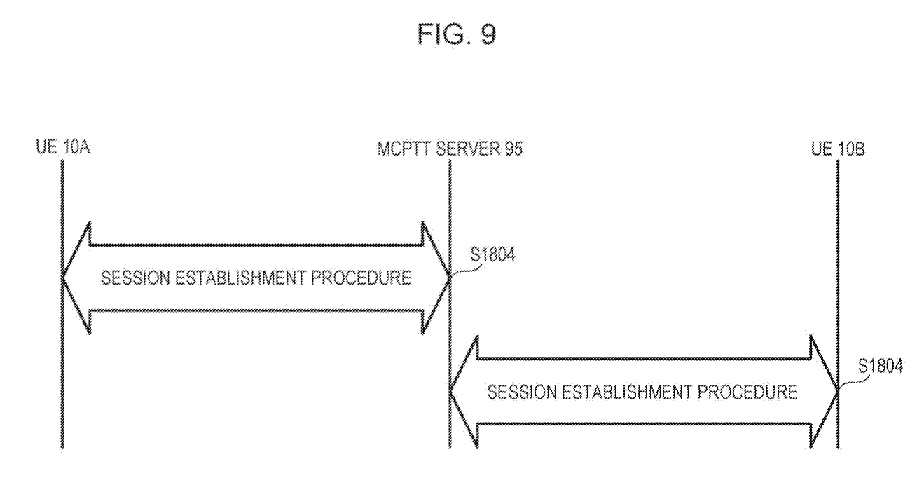

The session establishment procedure may be a pre-established session establishment procedure. A flow of processing by the pre-established session establishment procedure will be described with the use of FIG. 9. As illustrated in FIG. 9, in the pre-established session establishment procedure, the UE 10A performs a session establishment procedure with the MCPTT server 95 and the UE 10B performs a session establishment procedure with the MCPTT server 95 (S1804).

Note that, in the pre-established session establishment procedure, the session establishment is not performed for a specific user, but the session establishment is performed for a group. In the pre-established session establishment procedure, the UE 102 in which a service authentication procedure is completed performs a session establishment procedure so that the UE 10A participates in group communication. Moreover, the UE 10B in which a service authentication procedure is completed performs a session establishment procedure so that the UE 10B participates in group communication. The flow is similar to the flow of the processing described in FIG. 6 except for the session establishment procedure.

As a specific example of the pre-established session establishment procedure, a pre-established session establishment procedure 1 and a pre-established session establishment procedure 2 will be described.

Note that, the MCPTT server 95A is an MCPTT server 95 that manages the session of the UE 102 and the MCPTT server 95B is an MCPTT server 95 that manages the session of the UE 10B.

### [1.3.2.2.1 Pre-Established Session Establishment Procedure 1]

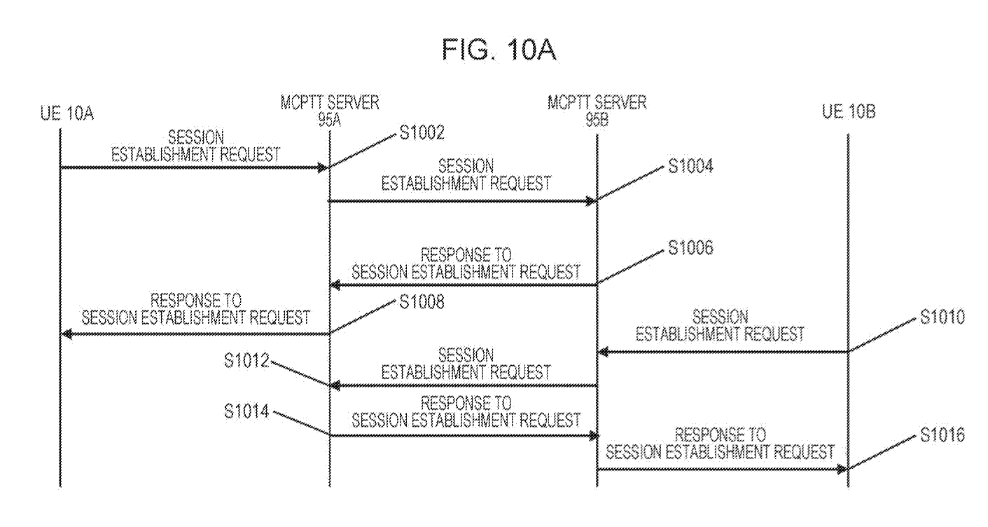

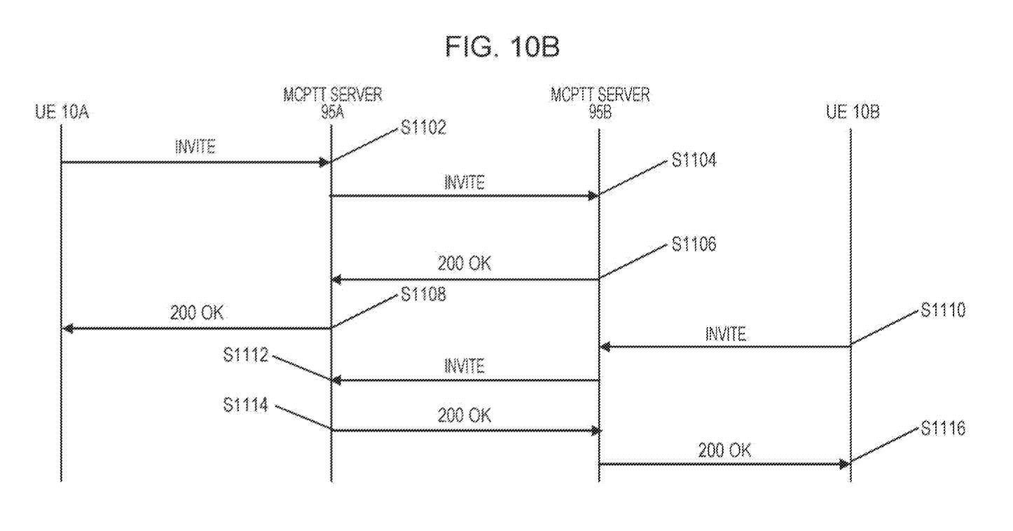

The pre-established session establishment procedure 1 will be described with the use of FIG. 10A. First, the UE 10A transmits a session establishment request to the MCPTT server 95A (S1002). Note that, the UE 10A includes the UE identifier of the UE 10A and a group identifier in the session establishment request.

The MCPTT server 95A receives the session establishment request. The MCPTT server 95A having received the session establishment request detects the UE identifier of the UE 10A and the group identifier which are included in the session establishment request. In this case, because of managing the UE identifier of the UE 10A and the group identifier, the MCPTT server 95A permits the UE 10A to establish the session. By permitting the session establishment, the MCPTT server 95A may newly assign a session identifier for managing the session.

The MCPTT server 95A then transmits, to the MCPTT server 95B that manages the session of the UE 10B, a session establishment request (S1004). The MCPTT server 95A includes the UE identifier of the UE 10A, the group identifier, and the session identifier in the session establishment request. In this case, the MCPTT server 95A may detect the MCPTT server 95B that manages the session of a group indicated by the group identifier and transmit the session establishment request to the MCPTT server 95B.

The MCPTT server 95A may perform management by associating the MCPTT server 95B and the group identifier in advance, and thereby detect that the session of the group indicated by the group identifier is managed by the MCPTT server 95B.

The MCPTT server 95A may query MCPTT servers 95 by using the group identifier in order to detect an MCPTT server 95 that manages the session of the group indicated by the group identifier, and detect an MCPTT server 95, from which an acknowledgement response is provided, as the MCPTT server 95B that manages the session of the group indicated by the group identifier.

Note that, a method of detecting the MCPTT server 951B, which manages the session of the group indicated by the group identifier, by the MCPTT server 95A may be any method as long as the MCPTT server 95B is able to be detected.

The MCPTT server 95B receives the session establishment request. The MCPTT server 95B detects the UE identifier of the UE 10A, the group identifier, and the session identifier which are included in the session establishment request. In this case, because of managing the group identifier, the MCPTT server 95B permits the session establishment in the group indicated by the group identifier.

The MCPTT server 95B transmits, to the MCPTT server 95A, a response to the session establishment request (S1006). The response to the session establishment request may include the UE identifier of the UE 10A, the group identifier, and the session identifier.

The MCPTT server 95A receives the response to the session establishment request. Upon reception of the response to the session establishment request, the MCPTT server 95A detects that the session establishment with the MCPTT server 95B has been permitted in the group indicated by the group identifier. In this case, the MCPTT server 95A may manage the session identifier, the UE identifier of the UE 10A, and the group identifier.

The MCPTT server 95A transmits, to the UE 10A, a response to the session establishment (S1008). The MCPTT server 95A may include the UE identifier of the UE 10A, the group identifier, and the session identifier in the response to the session establishment request.

The UE 10A receives the response to the session establishment. The UE 10A may detect the session identifier, the UE identifier of the UE 10A, and the group identifier, and manage the session identifier, the UE identifier of the UE 10A, and the group identifier.

With the aforementioned procedure, the UE 10A is able to establish the session in the group indicated by the group identifier.

On the other hand, the UE 10B is also able to establish the session with a procedure similar to that of the UE 10A. That is, the UE 10B transmits a session establishment request to the MCPTT server 95B (S1010), the MCPTT server 95B transmits a session establishment request to the MCPTT server 95A (S1012), the MCPTT server 95A transmits, to the MCPTT server 95B, a response to the session establishment request (S1014), and the MCPTT server 95B transmits, to the UE 10B, a response to the session establishment request (S1016), so that it is possible to establish the session in the group indicated by the group identifier.

Note that, the session establishment request transmitted by the UE 10B (S1010) corresponds to the session establishment request transmitted by the UE 10A (S1002), the session establishment request transmitted by the MCPTT server 95B (S1012) corresponds to the session establishment request transmitted by the MCPTT server 95B (S1004), the response to the session establishment request transmitted by the MCPTT server 95A (S1014) corresponds to the response to the session establishment request transmitted by the MCPTT server 95B (S1006), and the response to the session establishment transmitted by the MCPTT server 95B (S1016) corresponds to the response to the session establishment transmitted by the MCPTT server 95A (S1008).

In the aforementioned procedure, the UE 10B uses the same group identifier as that of the UE 10A, and receives the same session identifier as that of the UE 10A from the MCPTT server 95B.

With the aforementioned procedure, the UE 10A and the UE 10B are able to establish the session in the group indicated by the group identifier.

### [1.3.2.2.2 Pre-Established Session Establishment Procedure 2]

The pre-established session establishment procedure 2 will be described with the use of FIG. 10B. In the pre-established session establishment procedure 2, a session establishment procedure is performed by using a message in an SIP which is a session establishment protocol.

First, the UE 10A transmits an invite message to the MCPTT server 95A (S1102). Note that, the UE 10A includes the UE identifier of the UE 10A and a group identifier in the invite message.

The MCPTT server 95A receives the invite message. The MCPTT server 95A having received the invite message detects the UE identifier of the UE 10A and the group identifier which are included in the invite message in this case, because of managing the UE identifier of the UE 10A and the group identifier, the MCPTT server 95A permits the UE 10A to establish the session. By permitting the session establishment, the MCPTT server 95A may newly assign a session identifier for managing the session.

The MCPTT server 95A then transmits an invite message to the MCPTT server 95B that manages the session of the UE 10B (S1104). The MCPTT server 95A includes the UE identifier of the UE 10A, the group identifier, and the session identifier in the invite session message. In this case, the MCPTT server 95A may detect the MCPTT server 95B that manages the session of a group indicated by the group identifier and transmit the invite message to the MCPTT server 95B.

Note that, a method of detecting the MCPTT server 95B, which manages the session of the UE 10B, by the MCPTT server 95A has been described in the on-demand session establishment procedure 1, so that detailed description thereof will be omitted.

The MCPTT server 95B receives the invite message. The MCPTT server 95B detects the UE identifier of the UE 102, the group identifier, and the session identifier which are included in the invite message. In this case, because of managing the group identifier, the MCPTT server 95B permits the session establishment in the group indicated by the group identifier.

The MCPTT server 95B transmits a 200 OK message to the MCPTT server 95A (S1106). The MCPTT server 95B may include the UE identifier of the UE 10A, the group identifier, and the session identifier in the 200 OK message.

The MCPTT server 95A receives the 200 OK message. Upon reception of the 200 OK message, the MCPTT server 95A detects that the session establishment with the MCPTT serves 95B has been permitted in the group indicated by the group identifier. In this case, the MCPTT server 95A may manage the session identifier, the UE identifier of the UE 102, and the group identifier.

The MCPTT server 95A transmits, to the UE 10A, a response to session establishment (S1108). The MCPTT server 95A may include the UE identifier of the UE 10A, the group identifier, and the session identifier in the 200 OK message.

The UE 10A receives the response to the session establishment. The UE 10A may detect the session identifier, the UE identifier of the UE 10A, and the group identifier, and manage the session identifier, the UE identifier of the UE 10A, and the group identifier.

With the aforementioned procedure, the UE 10A is able to establish the session in the group indicated by the group identifier.

On the other hand, the UE 10B is also able to establish the session with a procedure similar to that of the UE 10A. That is, the UE 10B transmits an invite message to the MCPTT server 95B (S1110), the MCPTT server 95B transmits an invite message to the MCPTT server 95A (S1112), the MCPTT server 95A transmits a 200 OK message to the MCPTT server 95B (S1114), and the MCPTT server 95B transmits a 200 OK message to the UE 10B (S1116), so that it is possible to establish the session in the UE 10B.

Note that, the invite message transmitted by the UE 10B (S1110) corresponds to the invite message transmitted by the UE 10A (S1102), the invite message transmitted by the MCPTT server 95B (S1112) corresponds to the invite message transmitted by the MCPTT server 95B (S1104), the 200 OK message transmitted by the MCPTT server 95A. (S1114) corresponds to the 200 OK message transmitted by the MCPTT server 95B (S1106), and the response to the session establishment transmitted by the MCPTT server 95B (S1116) corresponds to the response to the session establishment transmitted by the MCPTT server 95A (S1108).

In the aforementioned procedure, the same group identifier as that of the UE 10A is used, and the UE 10B receives the same session identifier as that of the UE 10A from the MCPTT server 95.

With the aforementioned procedure, the UE 10A and the UE 10B are able to establish the session in the group indicated by the group identifier.

### [1.3.3. Transmission Request Procedure]

A specific example of a transmission request procedure will be described. The description will be given by assuming that audio data is transmitted from the UE 10A, which has performed the session establishment procedure, to the UE 10B in the transmission request procedure. Note that, specific examples of two transmission request procedures will be described as the transmission request procedure.

### [1.3.3.1 Transmission Request Procedure 1]

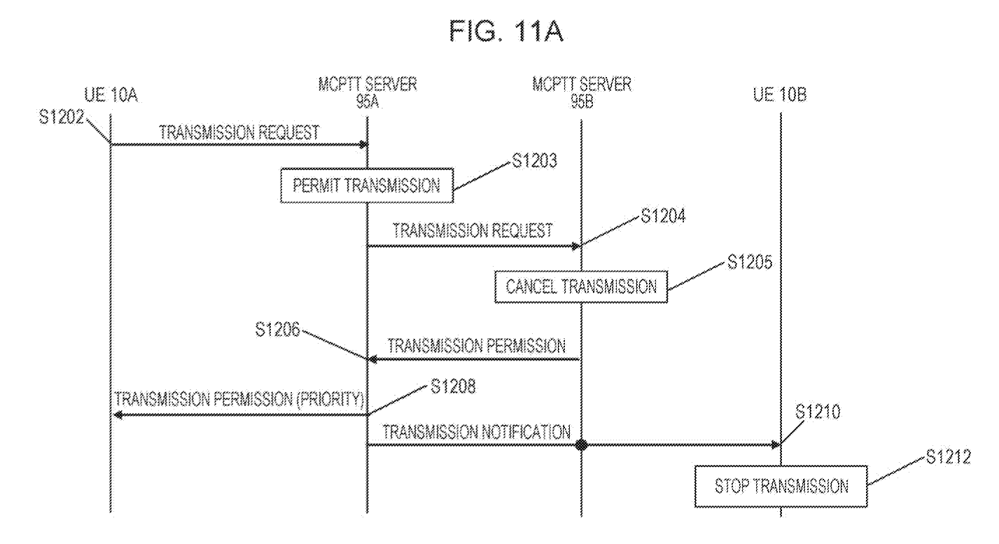

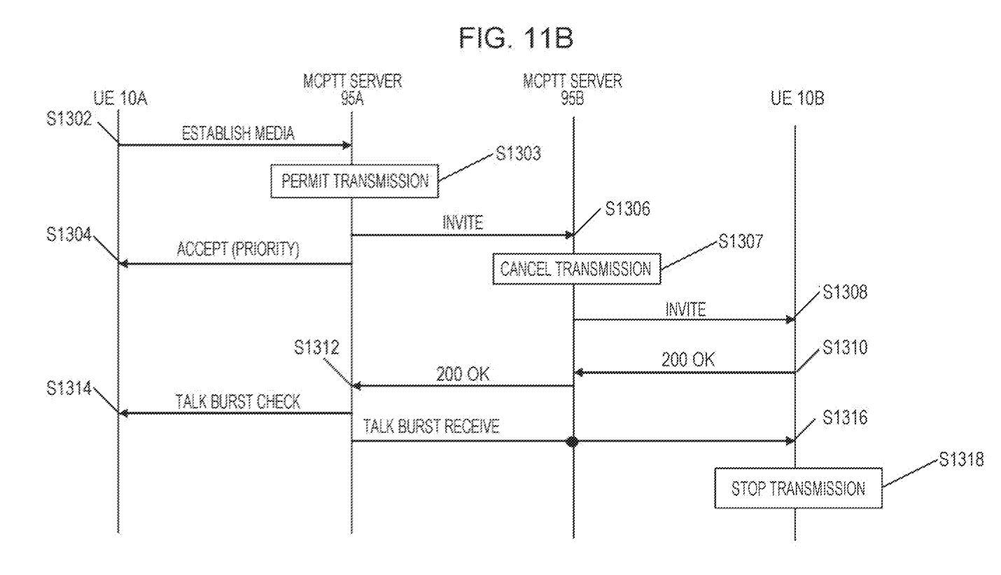

First, a transmission request procedure 1 will be described with the use of FIG. 11A. First, the UE 10A transmits a transmission request to the MCPTT server 95A (S1202). Note that, the UE 10A includes the UE identifier of the UE 10A, information about priority (for example, Highest), and a session identifier is the transmission request. In this case, the information about priority may be priority selected by a user from usable priority received in the service authentication procedure. When the user does not select priority, the UE 10A may include the highest priority of the usable priority.

The UE 10A may include information for identifying a UE type of the UE 10A in the transmission request.

The MCPTT server 95A receives the transmission request. The MCPTT server 95A detects the UE identifier of the UE 10A, the information about priority (Highest), and the session identifier which are included in the transmission request.

The MCPTT server 95A permits transmission of the UE 10A (S1203). First, the MCPTT server 95A checks a transmission state associated with the session identifier included in the transmission request. Here, since there is no UE identifier associated with the session identifier, the MCPTT server 95A per transmission. In this case, it is detected that the UE 10B is not managed by the MCPTT server 95A but managed by the MCPTT server

The MCPTT server 95A having detected that the UE 10B is managed by the MCPTT server 95B transmits a transmission request to the MCPTT server 95B (S1204). In this case, the MCPTT server 95A may include the session identifier, the UE identifier of the UE 10A, the UE identifier of the UE 10B, and the information about priority in the transmission request.

The MCPTT server 95B receives the transmission request. The MCPTT server 95B detects the UE identifier of the UE 10A, the UE identifier of the UE 10B, and the information about priority which are included in the transmission request.

The MCPTT server 95B then decides to cancel the transmission (S1205). First, the MCPTT server 95A checks a transmission state associated with the session identifier included in the transmission request. In this case, the MCPTT server 95B detects that, in a session indicated by the session identifier, the UE identifier of the UE 10B and the information about priority (for example, Normal) are associated with each other to be managed and the UE 10B uses the session.

Next, the MCPTT server 95B checks the information about priority (Highest) included in the transmission request transmitted from the MCPTT server 95B.

Further, the MCPTT server 95A compares priority (Normal) associated with the session identifier to the priority (Highest) included in the transmission request, and decides to cancel the transmission of the UE 10B because the priority included in the transmission request is higher priority.

As a result, the MCPTT server 95B is able to decide to cancel the transmission of the UE 10B.

The MCPTT server 95B having decided to cancel the transmission transmits transmission permission to the MCPTT server 95A (S1206). In this case, the transmission permission may include information indicating that the transmission is canceled. The transmission permission may include the session identifier, the UE identifier of the UE 10A, the UE identifier of the UE 10B, and the information about priority.

The MCPTT server 95A receives the transmission permission. The MCPTT server 95A decides to permit transmission in accordance with the transmission permission. The MCPTT server 95A may detect priority that is able to be used by the UE 10A. The MCPTT server 95A may notify the UE 10A of the detected priority, and thereby notify usable priority.

The MCPTT server 95B transmits transmission permission to the UE 10A (S1208). In this case, the MCPTT server 95A may include information about usable priority in the transmission permission. The MCPTT server 95A may include the session identifier, the UE identifier of the UE 10A, and the UE identifier of the UE 10B in the transmission permission.

The UE 10A receives the transmission permission. The UE 10A may detect the information about priority included in the transmission permission and update the information about priority that is managed by the UE 10A. Upon reception of the transmission permission, the UE 10A transmits data in the session indicated by the session identifier.

The MCPTT server 95A transmits transmission notification to the UE 10B (S1210). The MCPTT server 95A includes the session identifier, the UE identifier of the UE 10A, and the UE identifier of the UE 10B in the transmission notification.

The UE 10B receives the transmission notification. The UE 10B detects the session identifier, the UE identifier of the UE 10A, and the UE identifier of the UE 10B which are included in the transmission notification. Upon reception of the transmission notification, the UE 10B stops the transmission in the session indicated by the session identifier (S1212).

With the aforementioned procedure, it is possible that while the UE 10B is performing transmission, the UE 10B stops the transmission in response to a transmission request of the UE 10A and the UE 10A starts transmission.

### [1.3.3.2 Transmission Request Procedure 2]

First, a transmission request procedure 2 will be described with the use of FIG. 11B. In the transmission request procedure 2, a transmission request procedure is performed by using a message in an SIP which is a session establishment protocol.

First, the UE 102 transmits an establish media message to the MCPTT server 95A (S1302). Note that, the UE 10A includes the UE identifier of the UE 10A, information about priority (for example, Highest), and a session identifier in the establish media message. In this case, the information about priority may be priority selected by a user from usable priority. When the user does not select priority, the UE 10A may include the highest priority of the usable priority.

The UE 10A may include information for identifying a UE type of the UE 10A in the transmission request.

The MCPTT server 95A receives the establish media message. The MCPTT server 95A detects the UE identifier of the UE 10A, the information about priority (Highest), and the session identifier which are included in the establish media message.

The MCPTT server 95A permits transmission of the UE 10A (S1303). A method of permitting the transmission of the UE 10A by the MCPTT serves 95A is similar to the method (S1203) indicated in the transmission request procedure 1, so that detailed description thereof will be omitted.

The MCPTT server 95A may detect the information about priority that is able to be used by the UE 10A. The MCPTT server 95A may notify the UE 10A of the detected priority, and cause the UE 10A to update the information about usable priority.

The MCPTT server 95A may transmit an accept message (S1304). With the accept message, the information about usable priority may be notified.

The UE 10A receives the accept message. The UE 10A may detect the information about priority, which is included in the accept message, and detect the information about priority.

On the other hand, the MCPTT server 95A detects that the UE 10B is managed by the MCPTT server 95B.

The MCPTT server 95A having detected that the UE 10B is managed by the MCPTT server 95B transmits an invite message to the MCPTT server 95B (S1306). In this case, the MCPTT sever 95A may include the session identifier, the UE identifier of the UE 10A, the UE identifier of the UE 10B, and the information about priority in the invite message.

The MCPTT server 95B receives the invite message. The MCPTT server 95B detects the UE identifier of the UE 10A, the UE identifier of the UE 10B, and the information about priority which are included in the transmission request.

The MCPTT server 95B then decides to cancel transmission (S1307). A method of canceling the transmission of the UE 10A by the MCPTT server 95A is similar to the method (S1205) indicated in the transmission request procedure 1, so that detailed description thereof will be omitted.

The MCPTT server 95B having decided to cancel the transmission transmits an invite message to the UE 10B (S1308). In this case, the MCPTT server 95B may include the session identifier, the UE identifier of the UE 10A, the UE identifier of the UE 10B, and the information about priority in the invite message.

The UE 10B receives the invite message. The UE 10B detects the UE identifier of the UE 10A, the UE identifier of the UE 10B, and the information about priority which are included in the transmission request. The UE 10B permits the UE 10A in the session indicated by the session identifier.

The UE 10B transmits a 200 OK message to the MCPTT server 95B (S1310).

The MCPTT server 95B receives the 200 OK message and detects that the UE 10B has permitted the UE 10A to perform the transmission in the session indicated by the session identifier.

The MCPTT server 95B transmits a 200 OK message to the MCPTT server 95A (S1312). In this case, transmission permission may include information indicating that the transmission is canceled.

The MCPTT server 95A receives the 200 OK message. The MCPTT server 95A decides to permit the transmission is accordance with the 200 OK message.

The MCPTT server 95A transmits a talk burst check message to the UE 10A (S1314). The MCPTT server 95A may include the session identifier, the UE identifier of the UE 10A, and the UE identifier of the UE 10B in the talk burst check message.

The UE 10A receives the talk burst check message. Upon reception of the talk burst check message, the UE 10A transmits data in the session indicated by the session identifier.

The MCPTT server 95A transmits a talk burst receive message to the UE 10B (S1316). The MCPTT server 95A includes the session identifier, the UE identifier of the UE 10A, and the UE identifier of the UE 10B in the talk burst receive message.

The UE 10B receives the talk burst receive message. The UE 10B detects the session identifier, the UE identifier of the UE 10A, and the UE identifier of the UE 10B which are included in the talk burst receive message. Upon reception of the talk burst receive message, the UE 10B stops the transmission in the session indicated by the session identifier (S1312).

With the aforementioned procedure, it is possible that while the UE 10B is performing transmission, the UE 10B stops the transmission in response to a transmission request of the UE 10A and the UE 10A starts transmission.

### [1.4 Modified Example 1]

Though the service authentication procedure (S602) is performed in the first embodiment, in a case where the authentication procedure is not able to be performed with the service authentication server 90, for example, at the time of disaster, the service authentication procedure may not be performed. Though priority is notified with the service authentication procedure (S602) in the first embodiment, the priority may be notified with the session establishment procedure.

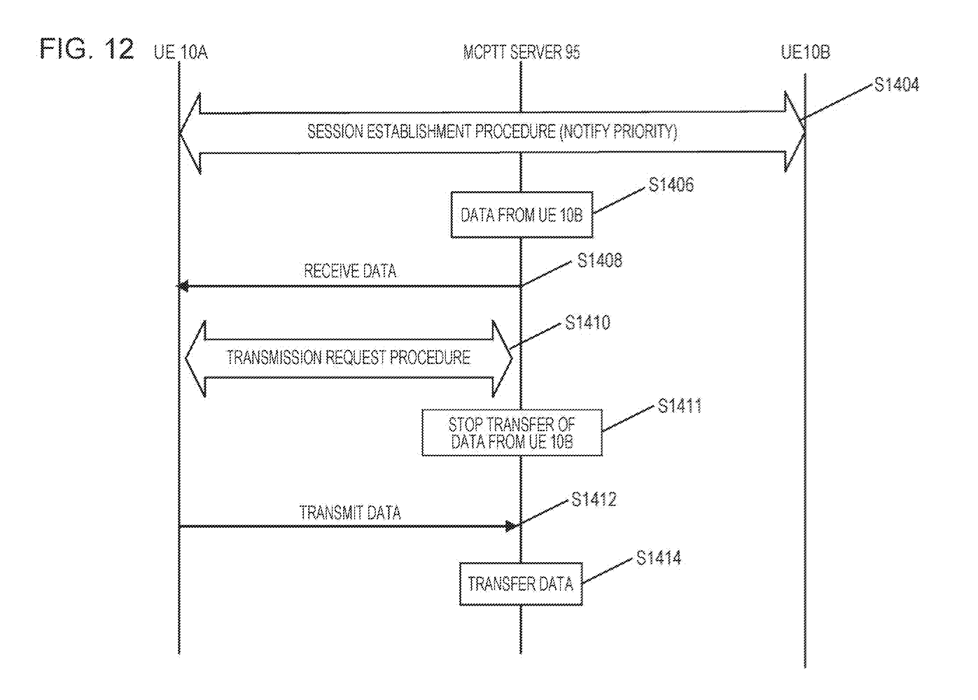

FIG. 12 illustrates a flow of processing in a modified example 1. First, the UE 10A performs a session establishment procedure with the UE 10P (S1404). In this case, with the session establishment procedure, priority is notified to the UE 10A and the UE 10B.

The subsequent procedure is similar to that of the first embodiment. That is, the MCPTT server 95 receives audio data from the UE 10B different from the UE 10A in the established session (S1406). The MCPTT server 95 transfers, to the UE 10A, the data transmitted from the UE 10B and the UE 10A receives the data from the UE 10B (S1408).

Further, while the UE 10B is performing transmission, transmission of data having high priority occurs in the UE 10A, and the UE 10A in which the transmission of data having high priority occurs performs a transmission request procedure (S1410). In this case, the MCPTT server 95 sets a time for the transmission of the UE 10B, and during the time that is set, the UE 10A causes transmission having high priority and performs a transmission request procedure.

The MCPTT server 95 makes comparison to priority associated with the audio data being transmitted, and decides to stop audio data of different UE (S1411).

On the other hand, the UE 10A which completes the transmission request procedure transmits the audio data to the MCPTT server 95 (S1412). The MCPTT server 95 transfers, to the different UE, the audio data received from the UE 10A (S1414).

With the aforementioned procedure, the UE 10A is able to preferentially transmit audio data having high priority on the basis of priority notified in the session establishment procedure. The MCPTT server 95 is able to interrupt the audio data being transmitted and transmit the audio data having high priority.

### [1.4.1 Session Establishment Procedure]

The session establishment procedure in the modified example 1 will be described. In the session establishment procedure of the modified example 1, priority that is able to be used by the UE 10A which transmits audio data is notified, and priority that is able to be used by the UE 10B which receives the audio data is notified. Note that, as the session establishment procedure in the modified example 1, there are an on-demand one and a pre-established one.

### [1.4.1.1 On-Demand Session Establishment Procedure]

First, the on-demand session establishment procedure will be described. The session establishment procedure in which the UE 10A requests session establishment to the UE performed. As a specific example of the on-demand session establishment procedure, an on-demand session establishment procedure 3 and an on-demand session establishment procedure 4 will be described.

### [1.4.1.1.1 On-Demand Session Establishment Procedure 3]

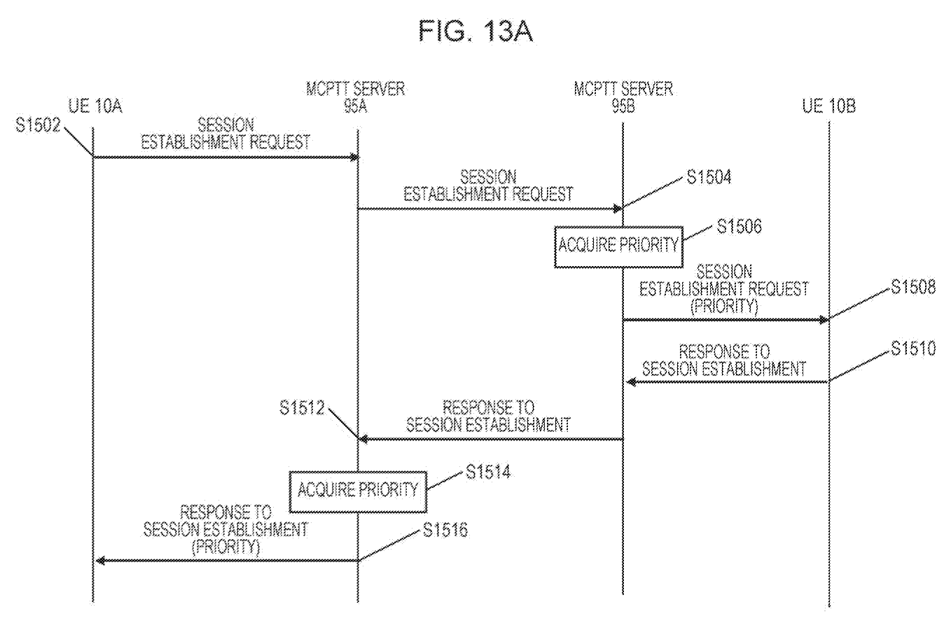

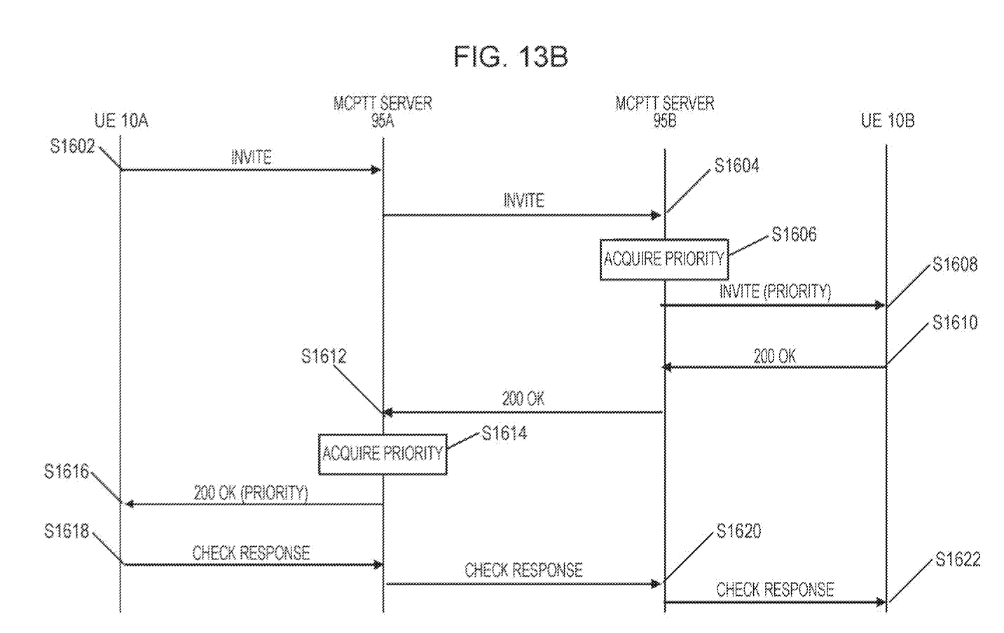

The on-demand session establishment procedure 3 will be described with the use of FIG. 13A. A difference from the on-demand session establishment procedure 1 which is described in the first embodiment and illustrated in FIG. 8A will be mainly described and description for a common part with the on-demand session establishment procedure 1 will be omitted.

First, the UE 10A transmits a session establishment request to the MCPTT server 95A (S1502). In this case, the UE 10 may include information about priority therein. Here, the information about priority, which is included by the UE 10A, may be information about priority requested by the UE 10A.

The MCPTT server 95A receives the session establishment request. The MCPTT server 95A having received the session establishment request may detect the information about priority, which is included in the session establishment request.

Next, the MCPTT server 95A transmits a session establishment request to the MCPTT server 95B that manages the session of the TB 10B (S1504). The MCPTT server 95B receives the session establishment request.

The MCPTT server 95B acquires the information about priority (S1506). The MCPTT server 95B may acquire the information about priority from the service authentication server 90. The MCPTT server 95B may query the service authentication server 90 by using the UE identifier of the UE 10B to thereby acquire the information about priority.

The MCPTT server 95B may acquire the information about priority from the HSS 50. The MCPTT server 95B may query the HSS 50 to thereby acquire the information about priority.

The MCPTT server 95B transmits a session establishment request to the BE 10B (81508). The MCPTT server 95B includes the acquired information about priority in the session establishment request.

The UE 10B receives the session establishment request. The UE 10B detects the information about priority, which is included in the session establishment request, and manages the information about priority.

The UE 10B transmits, to the MCPTT server 95B, a response to the session establishment request (S1510). The MCPTT server 95B receives, from the UE 10B, the response to the session establishment request.

The MCPTT server 95B transmits, to the MCPTT server 95A., a response to the session establishment request (S1512). The MCPTT server 95A receives the response to the session establishment request.

Upon reception of the response to the session establishment request, the MCPTT server 95A detects that the MCPTT server 95B and the UE 10B have permitted the session establishment with the UE 10A.

The MCPTT server 95A acquires the information about priority of the UE 10A (S1514). Note that, a method of acquiring the information about priority of the UE 10A by the MCPTT server 95A is similar to the method of acquiring the information about priority of the UE 10B by the MCPTT server 95B (S1506), so that detailed description thereof will be omitted.

Here, the MCPTT server 95A may authenticate the information about priority, which is included in the session establishment request (S1502) of the UE 10A. When having authenticated the information about priority included by the UE 10A, the MCPTT server 95A may perform notification to the UE 102 as the information about priority.

The MCPTT server 95A transmits, to the UE 10A, a response to the session establishment request (S1516). The MCPTT server 95A includes the information about priority in the response to the session establishment request.

The UE 10A receives the response to the session establishment request. The UE 10A detects the information about priority and manages the information about priority.

With the aforementioned procedure, the UE 10A and the UE 10B receive the information about priority and the UE 10A and the UE 10B are able to establish the session. By using the received information about priority in the transmission request procedure, the UE 10A and the UE 10B are able to perform transmission based on the information about priority.

### [1.4.1.1.2 On-Demand Session Establishment Procedure 4]

The on-demand session establishment procedure 4 will be described with the use of FIG. 13B. A difference from the on-demand session establishment procedure 2 which is described in the first embodiment and illustrated in FIG. 8B will be mainly described and description for a common part with the on-demand session establishment procedure 2 will be omitted.

First, the UE 10A transmits an invite message to the MCPTT server 95A (S1602). In this case, the UE 10 may include information about priority therein. Here, the information about priority, which is included by the UE 10, may be information about priority requested by the UE 10.

The MCPTT server 95A receives the invite message. The MCPTT server 95A having received the invite message may detect the information about priority, which is included in the invite message.

Next, the MCPTT server 95A transmits an invite message to the MCPTT server 95B (S1604). The MCPTT server 95A may include the information about priority in the invite message.

The MCPTT server 95B receives the invite message. The MCPTT server 95B may detect the information about priority, which is included in the invite message.

The MCPTT server 95B acquires the information about priority (S1606). Note that, a method of acquiring the information about priority by the MCPTT server 95B has been described in the on-demand session establishment procedure 3, so that detailed description thereof will be omitted.

The MCPTT server 95B transmits an invite message to the UE 10B (S1608). The information about priority is included in the invite message.

The UE 10B receives the invite message. The UE 10B detects the information about priority, which is included in the invite message, and manages the information about priority.

The UE 10B transmits a 200 OK message to the MCPTT server 95B (S1610). The MCPTT server 95B receives the 200 OK message from the UE 10B.

The MCPTT server 95B transmits a 200 OK message to the MCPTT server 95A (S1612). The MCPTT server 95A receives the 200 OK message.

The MCPTT server 95A acquires the information about priority of the UE 10A (S1614). Note that, a method of acquiring the information about priority of the UE 10A by the MCPTT server 95A has been described in the on-demand session establishment procedure 3, so that detailed description thereof will be omitted.

Here, the MCPTT server 95A may authenticate the information about priority, which is included in the invite message (S1602) of the UE 10A. When having authenticated the information about priority included by the UE 10A, the MCPTT server 95A may perform notification to the UE 10A as the information about priority.

The MCPTT server 95A transmits a 200 OK message to the UE 10A (S1616). The MCPTT server 95A includes the information about priority in the 200 OK message.

The UE 10A receives a response to a session establishment request. The UE 10A detects the information about priority and manages the information about priority.

With the aforementioned procedure, the UE 10A and the UE 10B receive the information about priority and the UE 10A and the UE 10B are able to establish the session. By using the received information about, priority in the transmission request procedure, the UE 10A and the UE 10B are able to perform transmission based on the information about priority.

### [1.4.1.2 Pre-Established Session Establishment Procedure]

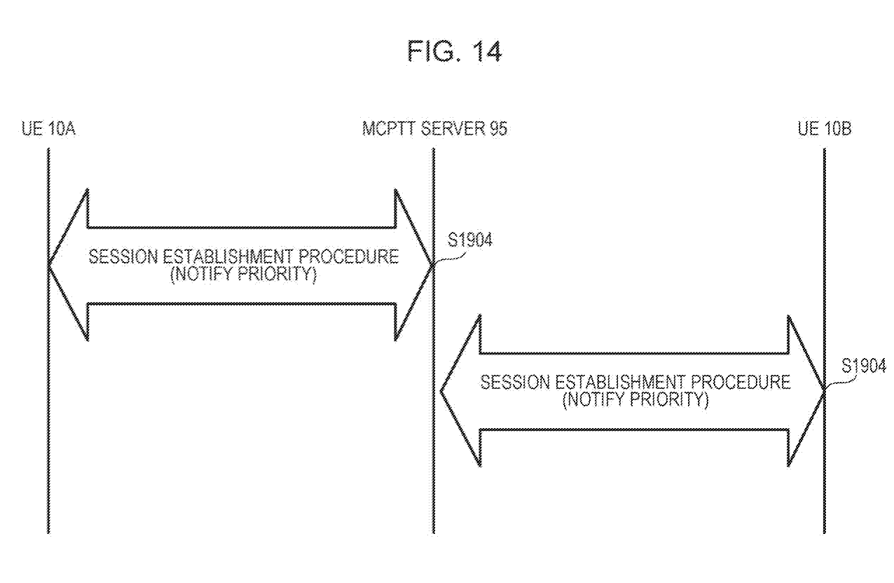

The session establishment procedure may be a pre-established session establishment procedure. A flow of processing by the pre-established session establishment procedure will be described with the use of FIG. 14. As illustrated in FIG. 14, in the pre-established session establishment procedure, the UE 10A performs a session establishment procedure with the MCPTT server 95 and the UE 10B performs a session establishment procedure with the MCPTT server 95 (S1904). Note that, by performing the session establishment procedure with the MCPTT server 95, the UE 10A acquires priority. By performing the session establishment procedure with the MCPTT 95, the UE 10B acquires priority. The flow is similar to the flow of the processing described in FIG. 12 except for the session establishment procedure.

As a specific example of the pre-established session establishment procedure, a pre-established session establishment procedure 3 and a pre-established session establishment procedure 4 will be described.

### [1.4.1.2.1 Pre-Established Session Establishment Procedure 3]

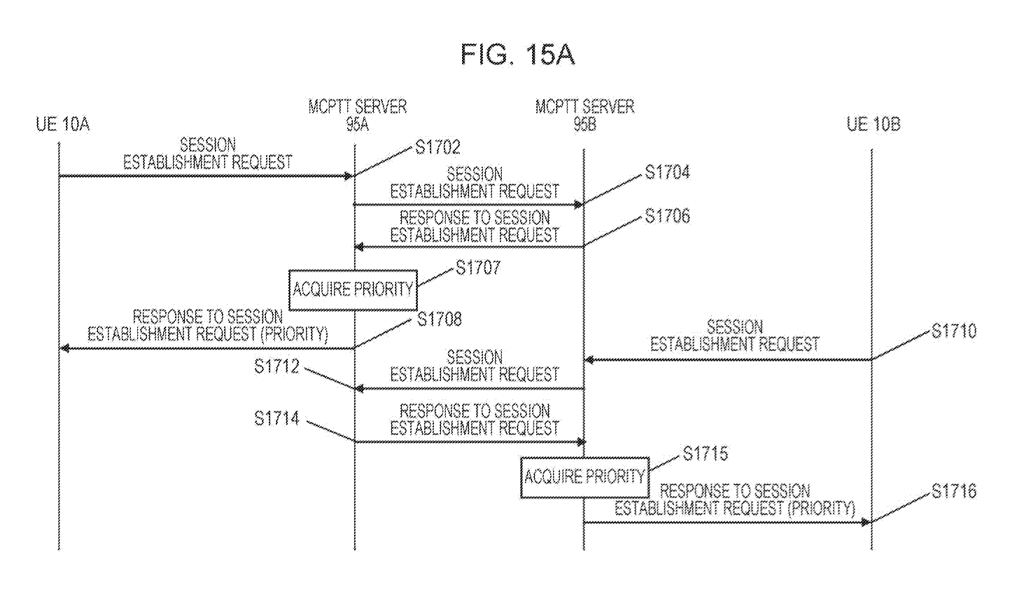

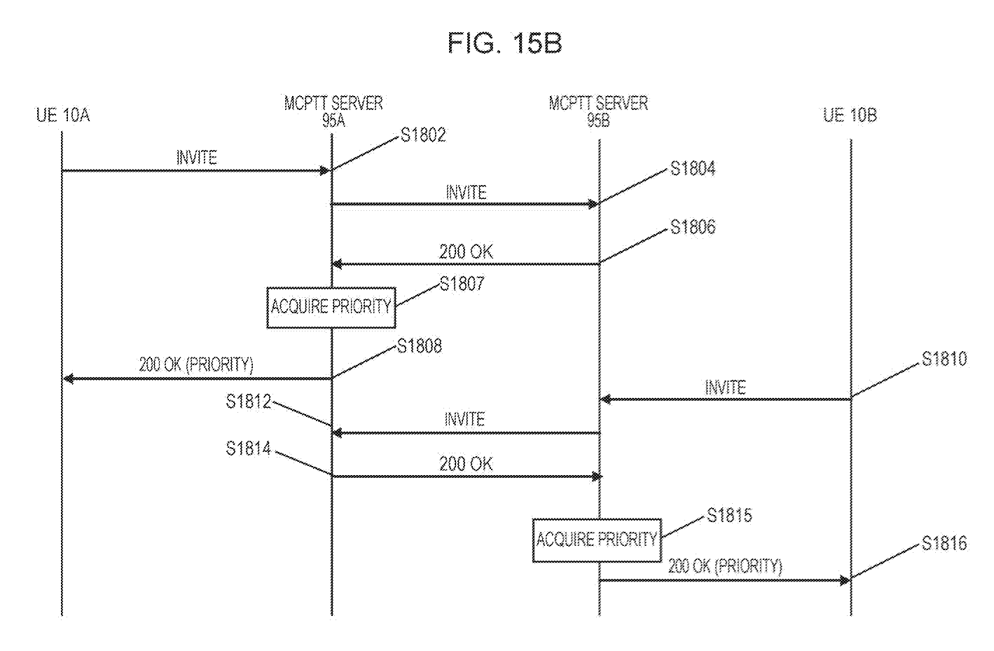

The on-demand session establishment procedure 3 will be described with the use of FIG. 15A. In the present procedure, a difference from the on-demand session establishment procedure 1 which is described in the first embodiment and illustrated in FIG. 10A will be mainly described and description for a common part with the on-demand session establishment procedure 1 will be omitted.

First, the UE 10A transmits a session establishment request to the MCPTT server 95A (S1702). Note that, the UE 102 may include information about priority in the session establishment request.

The MCPTT server 95A receives the session establishment request. The MCPTT server 95A having received the session establishment request may detect the information about priority, which is included in the session establishment request.

The MCPTT server 95A then transmits a session establishment request to the MCPTT server 95B that manages the session of the UE 10B (S1704). The MCPTT server 95B receives the session establishment request.

The MCPTT server 95B transmits, to the MCPTT server 95A, a response to the session establishment request (S1706). The MCPTT server 95A receives the response to the session establishment request.

The MCPTT server 95A acquires the information about priority (S1707). Note that, a method of acquiring the information about priority by the MCPTT server 95B has been described in the on-demand session establishment procedure 3, so that detailed description thereof will be omitted.

Here, the MCPTT server 95A may authenticate the information about priority, which is included in the session establishment request (S1702) of the UE 10A. When having authenticated the information about priority, which is included by the UE 10A, the MCPTT server 95A may perform notification to the UE 10A as the information about priority.

The MCPTT server 95A transmits, to the UE 10A, a response to the session establishment request (S1708). The information about priority may be included in the response to the session establishment request.

The UE 10A receives the response to the session establishment request. The UE 10A may detect the information about priority and manage the information about priority.

With the aforementioned procedure, the UE 10A is able to receive the information about priority and establish the session in a group indicated by a group identifier.

On the other hand, the UE 10B is also able to establish the session with a procedure similar to that of the UE 10A. That is, the UE 10B transmits a session establishment request to the MCPTT server 95B (S1710), the MCPTT server 95B transmits a session establishment request to the MCPTT server 95A (S1712), the MCPTT server 95A transmits, to the MCPTT server 95B, a response to the session establishment request (S1714), the MCPTT server 95B acquires priority (S1715), and the MCPTT server 95B transmits, to the UE 10B, a response to the session establishment request (S1716), so that it is possible to establish the session in a group indicated by a group identifier.

Note that, the session establishment request transmitted by the UE 10B (S1710) corresponds to the session establishment request transmitted by the UE 10A (S1702), the session establishment request transmitted by the MCPTT server 95B (S1712) corresponds to the session establishment request transmitted by the MCPTT server 95B (S1704), the response to the session establishment request transmitted by the MCPTT server 95A (S1714) corresponds to the response to the session establishment request transmitted by the MCPTT server 95B (S1706), the acquisition of priority by the MCPTT server 95B (S1715) corresponds to the acquisition of priority by the MCPTT server 95A (S1707), and the response to the session establishment request transmitted by the MCPTT server 95B (S1716) corresponds to the response to the session establishment request transmitted by the MCPTT server 95A (S1708).

With the aforementioned procedure, the UE 10A and the UE 10B are able to establish the session in the group indicated by the group identifier and receive priority.

### [1.4.1.2.2 Pre-Established Session Establishment Procedure 4]

The pre-established session establishment procedure 4 will be described with the use of FIG. 15B. In the present procedure, a difference from the on-demand session establishment procedure 2 which is described in the first embodiment and illustrated in FIG. 10B will be mainly described and description for a common part with the on-demand session establishment procedure 2 will be omitted.

First, the UE 10A transmits an invite message to the MCPTT server 95A (S1802). Note that, the UE 10A may include information about priority in the invite message.

The MCPTT server 95A receives the invite message. The MCPTT server 95A having received the invite message may detect the information about priority, which is included in the invite message.

The MCPTT server 95A then transmits an invite message to the MCPTT server 95B that manages the session of the UE 10B (S1804). The MCPTT server 95B receives the invite message.

The MCPTT server 95B transmits a 200 OK message to the MCPTT server 95A (S1806). The MCPTT server 95A receives the 200 OK message.

The MCPTT server 95A acquires the information about priority (S1807). Note that, a method of acquiring the information about priority by the MCPTT server 95B has been described in the on-demand session establishment procedure 3, so that detailed description thereof will be omitted.

Here, the MCPTT server 95A may authenticate the information about priority, which is included in the invite message (S1802) of the UE 10A. When having authenticated the information about priority, which is included by the UE 10A, the MCPTT server 95A may perform notification to the UE 10A as the information about priority.

The MCPTT server 95A transmits a 200 Ok message to the UE 10A (S1808). The information about priority may be included in the 200 OK message.

The UE 10A receives the 200 OK message. The UE 10A may detect the information about priority and manage the information about priority.

With the aforementioned procedure, the UE 10A is able to receive the information about priority and establish the session in a group indicated by a group identifier.

On the other hand, the UE 10B is also able to establish the session with a procedure similar to that of the UE 10A. That is, the UE 10B transmits an invite message to the MCPTT server 95B (S1810), the MCPTT server 95B transmits an invite message to the MCPTT server 95A (S1812), the MCPTT server 95A transmits a 200 OK message to the MCPTT server 95B (S1814), the MCPTT server 95B acquires priority (S1815), and the MCPTT server 951B transmits a 200 OK message to the UE 10B (S1816), so that it is possible to establish the session in a group indicated by a group identifier.

Note that, the invite message transmitted by the UE 10B (S1810) corresponds to the invite message transmitted by the UE 10A (S1802), the invite message transmitted by the MCPTT server 95B (S1812) corresponds to the invite message transmitted by the MCPTT server 95B (S1804), the 200 OK message transmitted by the MCPTT server 95A (S1814) corresponds to the 200 OK message transmitted by the MCPTT server 95B (S1806), the acquisition of priority by the MCPTT server 95B (S1815) corresponds to the acquisition of priority by the MCPTT server 95A (S1807), and the 200 OK message transmitted by the MCPTT server 95B (S1816) corresponds to the 200 OK message transmitted by the MCPTT server 95A (S1808).

With the aforementioned procedure, the UE 10A and the UE 10B are able to establish the session in the group indicated by the group identifier and receive priority.

### 2. Second Embodiment

A second embodiment will be described. In the second embodiment, when the UF 10 performs transmission, a session establishment procedure is performed and the transmission is started. Though a session is established in advance by a session establishment procedure and transmission is started by a transmission request procedure in the first embodiment, the session is established by the session establishment procedure and the transmission is started in the present embodiment.

Note that, in the present embodiment, a configuration of the mobile communication system in FIG. 1 is able to be used, so that detailed description thereof will be omitted.

A configuration of the UF in the mobile communication system, and configurations of the service authentication server 90 and the MCPTT server 95 are also able to be used similarly, so that detailed description thereof will be omitted.

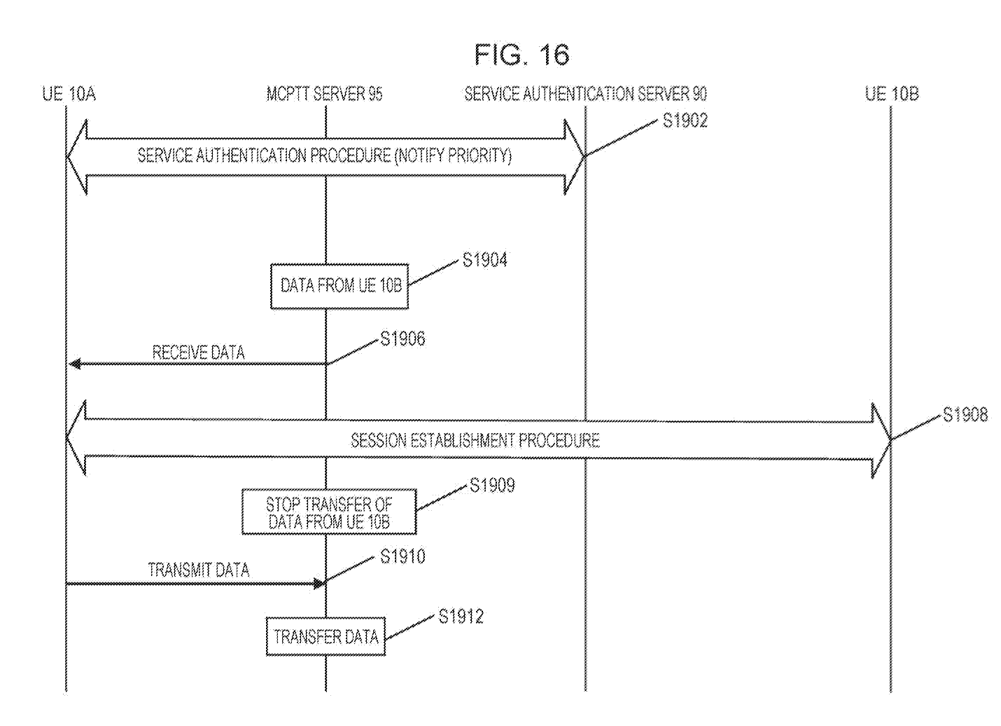

A flow of processing in the second embodiment will be described with the use of FIG. 16. First, the UE 10A performs a service authentication procedure with the service authentication server 90 (S1902). Note that, the service authentication procedure in the present embodiment is a similar procedure to that of the first embodiment, so that detailed description thereof will be omitted.

Then, the MCPTT server 95 receives audio data from the UE 10B (S1904). The MCPTT server 95 transfers, to the UE 10B, the data transmitted from the UE 10B. Thereby, the UE 10A receives the data from the UE 10B (S1906).

Note that, similarly to the UE 10A, the UE 10B transmits audio data to the MCPTT server 95 after performing the service authentication procedure (S1902) and the session establishment procedure (S1904). The UE 10A receives, from the MCPTT server 95, the audio data from the UE 10B (S1906) in the present embodiment, while the UE 10B is performing transmission, transmission of data having high priority occurs in the UE 10A. The UE 10A in which transmission of data having high priority occurs performs a session establishment procedure with the UE 10B (S1908). Note that, the UE 10A notifies the MCPTT server 95 of priority in the session establishment procedure. In this case, the MCPTT server 95 sets a time for the transmission of the UE 10B, and during the time that is set, the UE 10A causes transmission having high priority and performs the session establishment procedure.

The MCPTT server 95 detects the priority and compares the priority to priority associated with the audio data being transmitted, and decides to stop the audio data of the UE 10B (S1909).

On the other hand, the UE 10A in which a transmission request procedure is completed transmits the audio data to the MCPTT server 95 (S1910). The MCPTT server 95 transfers, to the UE 10B, the audio data received from the UE 10A (S1912).

With the aforementioned procedure, audio data having high priority is able to be preferentially transmitted on the basis of priority notified in the service authentication procedure. That is, the MCPTT server 95 is able to interrupt the audio data being transmitted and transmit the audio data having high priority.

### [2.1 Session Establishment Procedure]

The session establishment procedure in the second embodiment will be described. In the session establishment procedure of the second embodiment, transmission is started with the session establishment. Note that, as the session establishment procedure in the second embodiment, there are an on-demand session establishment procedure 5 and an on-demand session establishment procedure 6.

### [2.1.1 On-Demand Session Establishment Procedure 5]

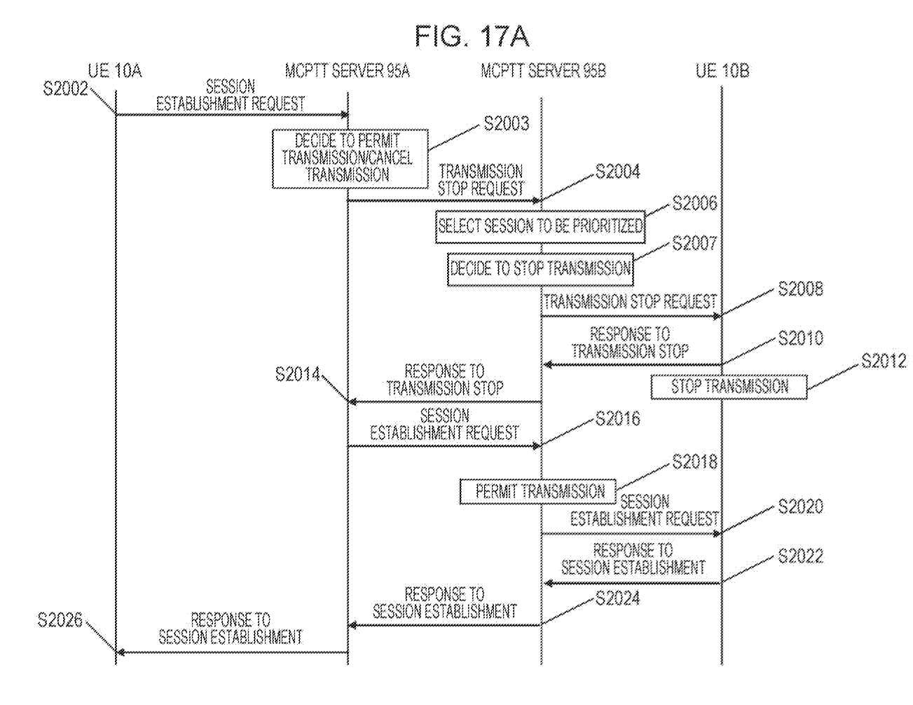

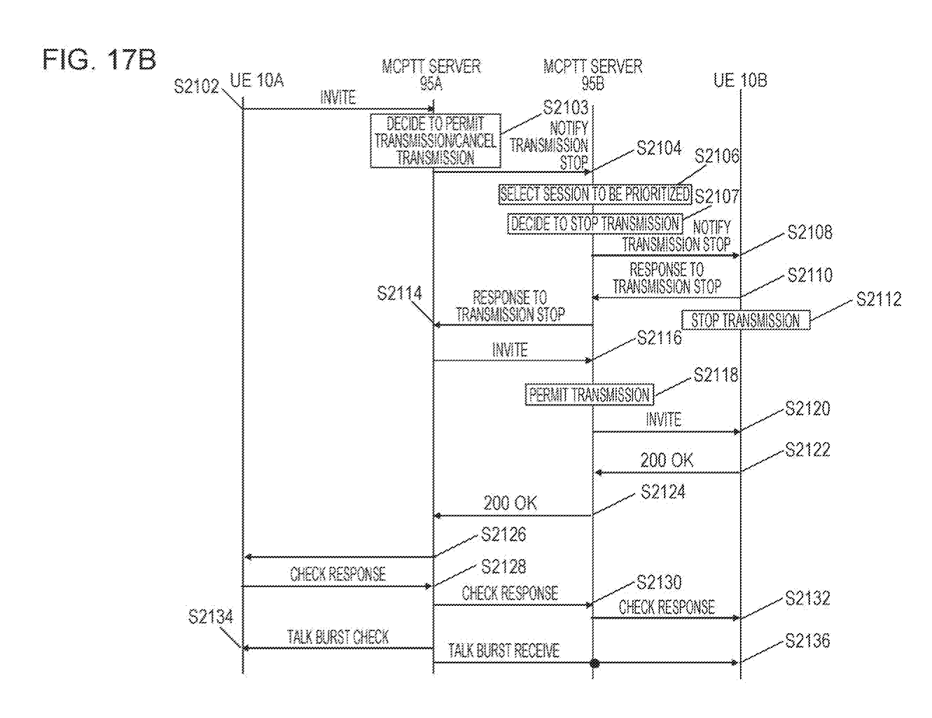

The on-demand session establishment procedure 5 will be described with the use of FIG. 17A. A difference from the on-demand session establishment procedure 1 which is described in the first embodiment and illustrated in FIG. 8A will be mainly described and description for a common part with the on-demand session establishment procedure 1 will be omitted.

First, the UE 10A transmits a session establishment request to the MCPTT server 95A (S2002). Note that, the UE 10A includes information about priority in the session establishment request.

The MCPTT server 95A receives the session establishment request. The MCPTT server 95A having received the session establishment request detects the information about priority, which is included in the session establishment request.

The MCPTT server 95A decides to permit transmission/cancel transmission (S2003). First, the MCPTT server 95A checks a session having the Lowest priority among sessions associated with the UE identifier of the UE 10A included in a transmission request. Then, the MCPTT server 95A compares the session having the lowest priority (for example, Highest) to the information about priority (for example, Highest), which is included in the session establishment request, and thereby decides to cancel the transmission in the session having the lowest priority.

In this case, the MCPTT server 95A compares the session having the lowest priority to the information about priority, which is included in the session establishment request, and because the information has the same priority, the MCPTT server 95A is not able to cancel the transmission in the session having the lowest priority.

The MCPTT server 95A detects the MCPTT server 95B that manages the session of the UE 10B. A method of detecting the MCPTT server 95B that manages the session of the UE 10B has been described in the first embodiment, so that detailed description thereof will be omitted.

The MCPTT server 95A transmits a transmission stop request to the MCPTT server 95B (S2004). Note that, the UE identifier of the UE 10A and the UE identifier of the UE 105 are included in the transmission stop request.

The MCPTT server 95B then receives the transmission stop request. The MCPTT server 95B detects the UE identifier of the UE 10A, the UE identifier of the UE 105, and the information about priority which are included in the transmission stop request.

The MCPTT server 95B selects a session to be prioritized (S2006). First, the MCPTT server 95B checks a session having the lowest priority among sessions associated with the UE identifier of the UE 10B included in a transmission request. Then, the MCPTT server 95A compares the session having the lowest priority (for example, Normal) to the information about priority (for example, Highest), which is included in the session establishment request, and thereby decides to cancel the transmission in the session having the lowest priority.

The MCPTT server 95B transmits a transmission stop request to the UE 10B (S2008). A session identifier 1 indicating the session the transmission of which is decided to be stopped is included in the transmission stop request. In this case, the transmission stop request may be information indicating that only the transmission is stopped while keeping the session.

The UE 10B receives the transmission stop request from the MCPTT server 95B. The UE 10B detects the session identifier 1. The UE 105 stops the transmission in the session indicated by the session identifier 1 (S2012).

The UE 10B further transmits, to the MCPTT server 95B, a response to the transmission stop (S2010). The MCPTT server 95B receives the response to the transmission stop. Upon reception of the response to the transmission stop, the MCPTT server 95B detects the transmission stop in the session indicated by the session identifier 1.

The MCPTT server 95B transmits, to the MCPTT server 95A, a response to the transmission stop (S2014). The MCPTT server 95B receives the response to the transmission stop. Upon reception of the response to the transmission stop, the MCPTT server 95A detects that the transmission is stopped in the session indicated by the session identifier 1, establishes a session in a new session, and detects that transmission is able to be performed therein.

In this case, the MCPTT server 95A may assign a session identifier 2 in the new session in which transmission is performed by the UE 10A.

The MCPTT server 95A then transmits a session establishment request to the MCPTT server 95B that manages the session of the UE 10B (S2016). The MCPTT server 95A includes the UE identifier of the UE 10A, the UE identifier of the UE 10B, and the session identifier 2 in the session establishment request. In this case, the MCPTT server 95A may detect the MCPTT server 95B that manages the session of the UE 10B and transmit the session establishment request to the MCPTT server 95B.

The MCPTT server 95A may perform management by associating the MCPTT server 95B and the UE 10B in advance, and thereby detect that the session of the UE 10B is managed by the MCPTT server 95B.

The MCPTT server 95B receives the session establishment request. The MCPTT server 95B detects the UE identifier of the UE 10A, the UE identifier of the UE 10B, and the session identifier 2 which are included in the session establishment request.

The MCPTT server 95B decides to permit transmission (S2018). In this case, because of managing the UE identifier of the UE 10B, the MCPTT server 95B may permit the UE 10B to establish the session indicated by the session identifier 2.

The MCPTT server 95B transmits a session establishment request to the UE 10B (S2020). The MCPTT server 95B includes the UE identifier of the UE 102 and the session identifier 2 in the session establishment request.

The UE 10B receives the session establishment request. The UE 10B detects the UE identifier of the UE 10A and the session identifier 2 which are included in the session establishment request. The UE 10B permits the session establishment with the UE 10A and manages the UE identifier of the UE 10A and the session identifier 2.

The UE 10B transmits, to the MCPTT server 95B, a response to the session establishment request (S2022). The UE identifier of the UE 10A, the UE identifier of the UE 10B, and the session identifier 2 may be included in the response to the session establishment request.

The MCPTT server 95B receives, from the UE 10B, the response to the session establishment request. Upon reception of the response to the session establishment request, the MCPTT server 95B detects that the UE 10B has permitted establishment of the session indicated by the session identifier 2 with the UE 10A. In this case, the MCPTT server 95B may manage the session identifier 2, the UE identifier of the UE 10A, and the UE identifier of the UE 10B.

The MCPTT server 95B transmits, to the MCPTT server 95A, a response to the session establishment request (S2024). The UE identifier of the UE 10A, the UE identifier of the UE 10B, and the session identifier 2 are included in the response to the session establishment request.

The MCPTT server 95A receives the response to the session establishment request. Upon reception of the response to the session establishment request, the MCPTT server 95A detects that the MCPTT server 95B and the UE 10B Save permitted the session establishment with the UE 10A. In this case, the MCPTT server 95A may manage the session identifier 2, the UE identifier of the UE 10A, and the UE identifier of the UE 10B.

The MCPTT server 95A transmits, to the UE 10A, a response to the session establishment request (S2026). The MCPTT server 95A may include the UE identifier of the UE 10A, the UE identifier of the UE 10B, and the session identifier 2 in the response to the session establishment request.

The UE 10A receives the response to the session establishment request. The UE 10A may detect the session identifier, the UE identifier of the UE 10A, and the UE identifier of the UE 10B and manage the session identifier, the UE identifier of the UE 10A, and the UE identifier 2 of the UE 10B.

With the aforementioned procedure, the UE 10A is able to stop the transmission in the session with the UE 10B, which is indicated by the session identifier 1, and establish the session indicated by the session identifier 2 to start transmission.

### [2.1.2 On-Demand Session Establishment Procedure 6]

The on-demand session establishment procedure 6 will be described with the use of FIG. 17B. A difference from the on-demand session establishment procedure 2 which is described in the first embodiment and illustrated in FIG. 8B will be mainly described and description for a common part with the on-demand session establishment procedure 2 will be omitted.

First, the UE 10A transmits an invite message to the MCPTT server 95A (S2102). Note that, the UE 10A includes information about priority in the invite message.

The MCPTT server 95A receives the invite message. The MCPTT server 95A having received the invite message detects the information about priority, which is included is the invite message.

The MCPTT server 95A decides to permit transmission/cancel transmission (S2103), the MCPTT server 95A transmits a transmission stop request to the MCPTT server 95B (S2104), the MCPTT server 95B selects a session to be prioritized (S2106), the MCPTT server 95B transmits a transmission stop request to the UE 10B (S2108), the UE 10B stops the transmission in the session (S2112), the UE 10B transmits, to the MCPTT server 95B, a response to the transmission stop (S2110), and the MCPTT server 95B transmits, to the MCPTT server 95A, a response to the transmission stop (S2114).

Here, the procedure from S2103 to S2114 is similar to the procedure of the on-demand session establishment procedure 5, so that detailed description thereof is omitted.

Next, the MCPTT server 95A transmits an invite message to the MCPTT server 95B that manages the session of the UE 10B (S2116). The MCPTT server 95A includes the UE identifier of the UE 10A, the UE identifier of the UE 10B, and the session identifier 2 in the invite message. In this case, the MCPTT server 95A may detect the MCPTT server 95B that manages the session of the UE 10B and transmit the invite message to the MCPTT server 95B.

The MCPTT server 95A may perform management by associating the MCPTT server 95B and the UE 10B in advance, and thereby detect that the session of the UE 10B is managed by the MCPTT server 95B.

The MCPTT server 95B receives the invite message. The MCPTT server 95B detects the UE identifier of the UE 10A, the UE identifier of the UE 10B, and the session identifier 2 which are included in the invite message.

The MCPTT server 95B decides to permit transmission (S2118). In this case, because of managing the UE identifier of the UE 10B, the MCPTT server 95B may permit the UE 10B to establish the session indicated by the session identifier 2.

The MCPTT server 95B transmits an invite message to the UE 10B (S2120). The MCPTT server 95B includes the UE identifier of the UE 10A and the session identifier 2 in the invite message.

The UE 10B receives the invite message. The UE 10B detects the UE identifier of the UE 10A and the session identifier 2 which are included in the invite message. The UE 10B permits the session establishment with the UE 10A and manages the UE identifier of the UE 10A and the session identifier 2.

The UE 10B transmits a 200 OK message to the MCPTT server 95B (S2122). The UE 10B may include the UE identifier of the UE 10A, the UE identifier of the UE 10B, and the session identifier 2 in the 200 OK message.

The MCPTT server 95B receives the 200 OK message from the UE 10B. Upon reception of the 200 OK message, the MCPTT server 95B detects that the UE 10B has permitted establishment of the session with the UE 10A, which is indicated by the session identifier 2. In this case, the MCPTT server 95B may manage the session identifier 2, the UE identifier of the UE 10A, and the UE identifier of the UE 10B.

The MCPTT server 95B transmits a 200 OK message to the MCPTT server 95A (S2124). The MCPTT server 95B includes the UE identifier of the UE 10A, the UE identifier of the UE 10B, and the session identifier 2 in the 200 OK message.

The MCPTT server 95A receives the 200 OK message. Upon reception of the 200 OK message, the MCPTT server 95A detects that the MCPTT server 95B and the UE 10B have permitted the session establishment with the UE 10A. In this case, the MCPTT server 95A may manage the session identifier 2, the UE identifier of the UE 10A, and the UE identifier of the UE 10B.

The MCPTT server 95A transmits the 200 OK message to the UE 10A (S2126). The MCPTT server 95A may include the UE identifier of the UE 10A, the UE identifier of the UE 10B, and the session identifier 2 in the 200 OK message.

The UE 10A receives the 200 OK message. The UE 10A may detect the session identifier, the UE identifier of the UE 10A, and the UE identifier of the UE 10B and manage the session identifier, the UE identifier of the UE 10A, and the UE identifier 2 of the UE 10B.

The UE 10A transmits a check response to the MCPTT server 95A, (S2128), the MCPTT server 95A transmits a check response to the MCPTT server 95B (S2130), and the MCPTT server 95B transmits a check response to the UE 10B (S2132). The UE 10A is able to receive the 200 OK message from the UE 10B as a response to the invite message and notify the UE 10B of the check response indicating that the response to the invite message has been received.

The MCPTT server 95A transmits a talk burst check message to the UE 10A (S2134). By transmitting the talk burst check message, the MCPTT server 95A notifies the UE 102 of start of the transmission. The MCPTT server 95A may include a session identifier of a session in which the transmission is to be started, the UE identifier of the UE 10A, and the UE identifier of the UE 10B in the talk burst check message.

The MCPTT server 95A further transmits a talk burst receive message to the UE 10B via the MCPTT server 95B (S2136). By transmitting the talk burst receive message, the MCPTT server 95A notifies the UE 10B of start of the transmission. The session identifier of the session in which the transmission is to be started, the UE identifier of the UE 10A, and the UE identifier of the UE 10B may be included in the talk burst receive message.

With the aforementioned procedure, the UE 10A is able to stop transmission in a session with the UE 10B, which is indicated by the session identifier 1, and establish a session indicated by the session identifier 2 to start transmission.

### [2.4 Modified Example 2]

Though the service authentication procedure (S1902) is performed in the second embodiment, the service authentication procedure may not be performed. Moreover, though priority is notified by the service authentication procedure (S1902) in the second embodiment, priority may be notified by the session establishment procedure.

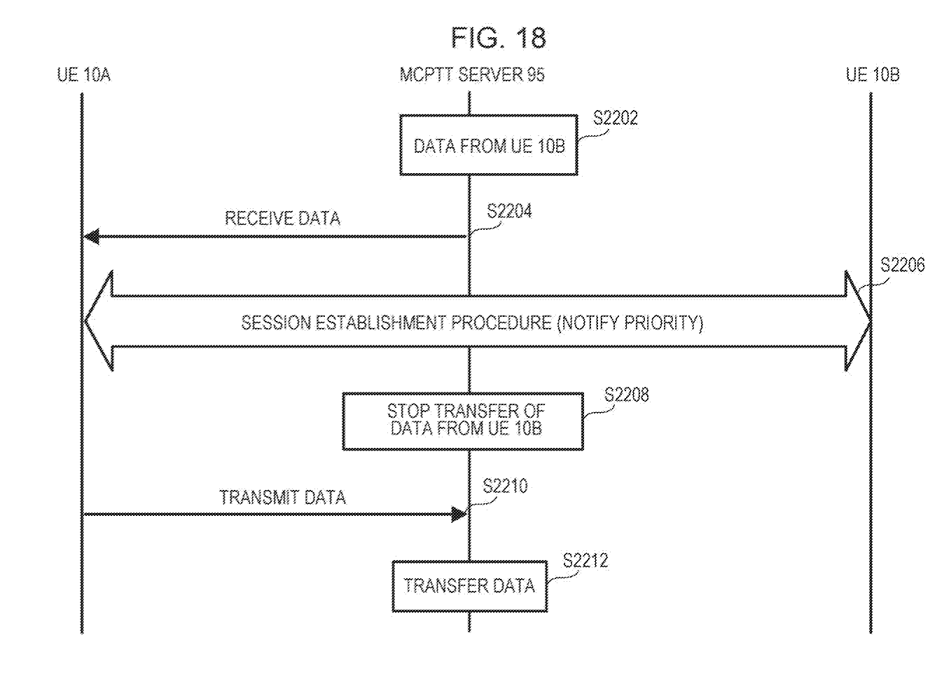

FIG. 18 illustrates a flow of processing in a modified example 2. First, the MCPTT server 95 receives audio data from the UE 10B (S2202). The MCPTT server 95 transfers data, which is transmitted from different UF, to the UE 10B. Thereby, the UE 102 receives the data from the UE 10B (S2204).

Note that, similarly to the UE 10A, the UE 10B also performs a session establishment procedure (S2202), and then transmits audio data to the MCPTT server 95. From the MCPTT server 95, the UE 10A receives the audio data from the UE 10B (S2204).

In the present embodiment, while the UE 10B is performing transmission, transmission of data having high priority occurs in the UE 10A. The UE 10A in which transmission of data having high priority occurs performs a session establishment procedure with the UE 10B (S2206). In this case, the UE 10A is notified of priority from the MCPTT server 95 in the session establishment procedure. Note that, the UE 10A is able to use the notified priority for the subsequent session establishment procedure. The UE 10B may hold information about priority in advance and use it for the session establishment procedure.

In this case, the MCPTT server 95 sets a time for the transmission of the UE 10B, and during the time that is set, the UE 10A causes transmission having high priority and performs a session establishment procedure.

The subsequent procedure is similar to that of the second embodiment. That is, the MCPTT server 95 stops the transmission of the audio data of the UE 10B (S2208).

On the other hand, the UE 10A which completes a transmission request procedure transmits audio data to the MCPTT server 95 (S2210). The MCPTT server 95 transfers, to the UE 10B, the audio data received from the UE 10A (S2212).

With the aforementioned procedure, audio data having high priority is able to be preferentially transmitted on the basis of priority notified in the session establishment procedure. That is, the MCPTT server 95 is able to interrupt the audio data being transmitted and transmit the audio data having high priority.

### [2.4.1 Session Establishment Procedure]

The session establishment procedure in the modified example 2 will be described. In the session establishment procedure of the modified example 2, priority that is able to be used by the UE 10A which transmits audio data is notified, and priority that is able to be used by the UE 10B which receives the audio data is notified. Note that, the session establishment procedure in the modified example 2 has an on-demand session establishment procedure 7 and an on-demand session establishment procedure 8.

### [2.4.1.1 On-Demand Session Establishment Procedure 7]

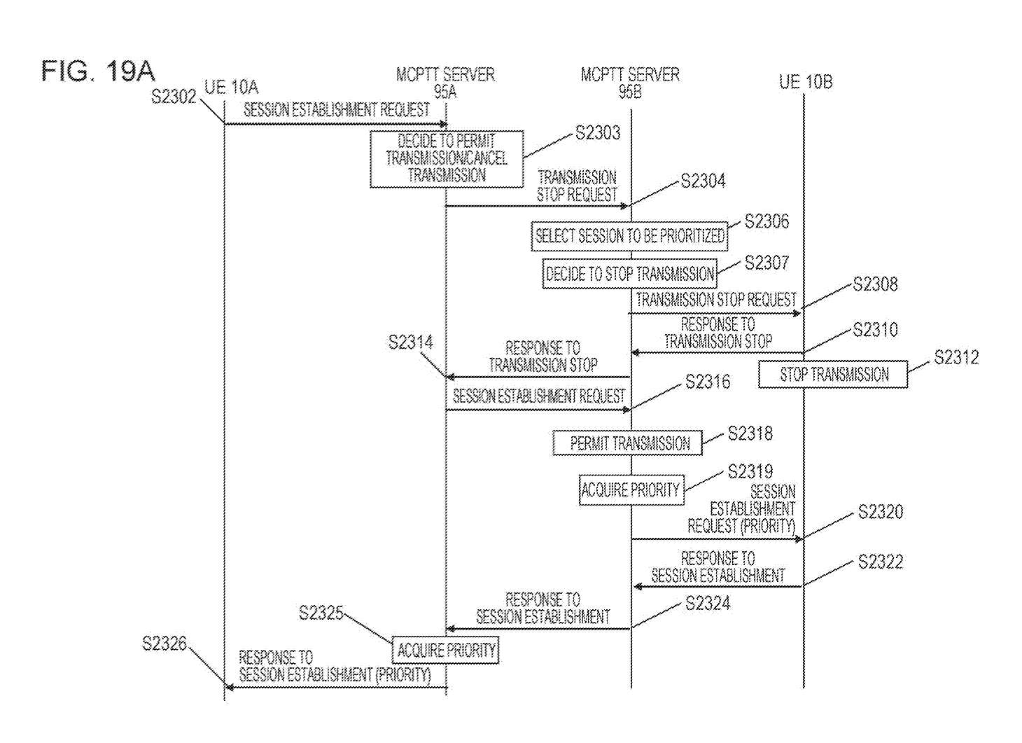

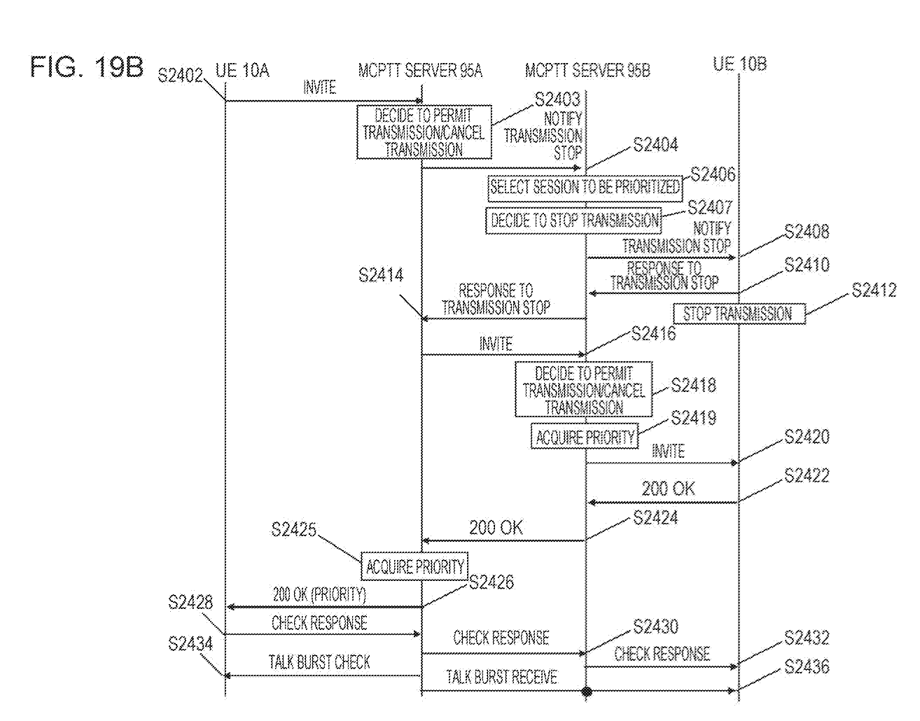

The on-demand session establishment procedure 7 will be described with the use of FIG. 19A. A difference from the on-demand session establishment procedure 5 which is described in the second embodiment and illustrated in FIG. 17A will be mainly described and description for a common part with the on-demand session establishment procedure 5 will be omitted.

First, the UE 10A transmits a session establishment request to the MCPTT server 95A (S2302). Note that, the UE 10A may include information about priority in the session establishment request.

The MCPTT server 95A receives the session establishment request. The MCPTT server 95A having received the session establishment request may detect the information about priority, which is included in the session establishment request.

The MCPTT server 95A decides to permit transmission/cancel transmission (S2303). In this case, the MCPTT server 95A may detect the information about priority, which is included in the session establishment request. The MCPTT server 95A may acquire the information about priority. A method of acquiring the information about priority by the MCPTT server 95A has been described in the modified example 1, so that detailed description thereof will be omitted.

Further, the MCPTT server 95A may use information about priority, which is acquired by acquiring the information about priority, to authenticate the information about priority, which is included in the session establishment request. When having authenticated the information about priority, which is included in the session establishment request, the MCPTT server 95A may use the information about priority for deciding to permit transmission/cancel transmission.

The method described in the second embodiment is able to be used to decide to permit transmission/cancel transmission with the use of the information about priority, so that detailed description thereof will be omitted.

The MCPTT server 95A detects the MCPTT server 95B that manages the session of the UE 10B. A method of detecting the MCPTT server 953 that manages the session of the UE 10B has been described in the first embodiment, so that detailed description thereof will be omitted.

The MCPTT server 95A transmits a transmission stop request to the MCPTT server 95B (S2304), the MCPTT server 955 selects a session to be prioritized (S2306), the MCPTT server 955 transmits a transmission stop request to the UE 105 (S2308), the UE 105 stops transmission in a session indicated by the session identifier 1 (S2312), the UE 105 transmits a response to the transmission stop to the MCPTT server 95B (S2310), the MCPTT server 955 transmits a response to the transmission stop to the MCPTT server 95A. (S2314), the MCPTT server 95A transmits a session establishment request to the MCPTT server 95B that manages the session of the UE 10B (S2316), and the MCPTT server 955 permits transmission (S2318). Here, the procedure from S2304 to S2318 is similar to the procedure of the on-demand session establishment procedure 7 described in the second embodiment, so that detailed description thereof will be omitted.

The MCPTT server 955 acquires information about priority (S2319). A method of acquiring the information about priority by the MCPTT server 95B has been described in the modified example 1, so that detailed description thereof will be omitted.

The MCPTT server 95B transmits a session establishment request to the UE 10B (S2320). The MCPTT server 95B includes the acquired information about priority in the session establishment request.

The UE 10B receives the session establishment request. The UE LOB detects the information about priority, which is included in the session establishment request. The UE 10B may manage the information about priority.

The UE 10B transmits, to the MCPTT server 95B, a response to the session establishment request (S2322) and the MCPTT server 95B transmits, to the MCPTT server 95A, a response to the session establishment request (S2324). Here, the procedure of S2322 and S2324 is similar to the procedure of the on-demand session establishment procedure 7 described in the second embodiment, so that detailed description thereof will be omitted.

The MCPTT server 95A acquires the information about priority (S2325). A method of acquiring the information about priority by the MCPTT server 95B has been described in the modified example 1, so that detailed description thereof will be omitted. Note that, when having acquired the information about priority in the decision to permit transmission/cancel transmission (S2303), the MCPTT server 95A may not acquire the information about priority.

The MCPTT server 95A transmits, to the UE 10A, a response to the session establishment request (S2326). The MCPTT server 95A includes the information about priority in the response to the session establishment request.

The UE 10A receives the response to the session establishment request. The UE 10A may detect the information about priority and manage the information about priority.

With the aforementioned procedure, the UE 10A is able to stop the transmission in the session with the UE 10B, which is indicated by the session identifier 1, and establish the session indicated by the session identifier 2 to start transmission. The UE 10A is also able to acquire information about usable priority by the session establishment procedure.

### [2.4.1.2 On-Demand Session Establishment Procedure 8]

The on-demand session establishment procedure 8 will be described with the use of FIG. 19B. A difference from the on-demand session establishment procedure 6 which is described in the second embodiment and illustrated in FIG. 17B will be mainly described and description for a common part with the on-demand session establishment procedure 6 will be omitted.

First, the UE 10A transmits an invite message to the MCPTT server 95A (S2402). Note that, the UE 10A may include information about priority in the invite message.

The MCPTT server 95A receives the invite message. The MCPTT server 95A having received the invite message may detect the information about priority, which is included in the invite message.

The MCPTT server 95A decides to permit transmission/cancel transmission (S2403). In this case, the MCPTT server 95A may detect the information about priority, which is included in the invite message. The MCPTT server 95A may acquire the information about priority. A method of acquiring the information about priority by the MCPTT server 95A has been described in the modified example 1, so that detailed description thereof will be omitted.

Further, the MCPTT server 95A may use information about priority, which is acquired by acquiring the information about priority, to authenticate the information about priority, which is included in the invite message. When having authenticated the information about priority, which is included in the invite message, the MCPTT server 95A may use the information about priority for deciding to permit transmission/cancel transmission.

The method described in the second embodiment is able to be used to decide to permit transmission/cancel transmission with the use of the information about priorty, so that detailed description thereof will be omitted.

The MCPTT server 95A detects the MCPTT server 95B that manages the session of the UE 10B. A method of detecting the MCPTT server 95B that manages the session of the UE 10B has been described in the first embodiment, so that detailed description thereof will be omitted.

The MCPTT server 95A transmits a transmission stop request to the MCPTT server 95B (S2404), the MCPTT server 95B selects a session to be prioritized (S2406), the MCPTT server 95B transmits a transmission stop request to the UE 10B (S2408), the UE 10B stops transmission in a session indicated by the session identifier 1 (S2412), the UE 10B transmits a response to the transmission stop to the MCPTT server 95B (S2410), the MCPTT server 95B transmits a response to the transmission stop to the MCPTT server 95A (S2414), the MCPTT server 95A transmits an invite message to the MCPTT server 95B that manages the session of the UE 10B (S2416), and the MCPTT server 95B permits transmission (S2418). Here, the procedure from S2404 to S2418 is similar to the procedure of the on-demand session establishment procedure 5 described in the second embodiment, so that detailed description thereof will be omitted.

The MCPTT server 95B acquires the information about priority (S2419). A method of acquiring the information about priority by the MCPTT server 95B has been described in the modified example 1, so that detailed description thereof will be omitted.

The MCPTT server 95B transmits an invite message to the UE 10B (S2420). The MCPTT server 95B includes the acquired information about priority in the invite message.

The UE 10B receives the invite message. The UE 10B detects the information about priority, which is included is the invite message. The UE 10B may manage the information about priority.

The UE 10B transmits a 200 OK message to the MCPTT server 95B (S2422) and the MCPTT server 95B transmits a 200 OK message to the MCPTT server 95A (S2424). Here, the procedure of S2422 and S2424 is similar to the procedure of the on-demand session establishment procedure 7 described in the second embodiment, so that detailed description thereof will be omitted.

The MCPTT server 95A acquires the information about priority (S2425). A method of acquiring the information about priority by the MCPTT server 95B has been described in the modified example 1, so that detailed description thereof will be omitted. Note that, when having acquired the information about priority in the decision to permit transmission/cancel transmission. (S2403), the MCPTT server 95A may not acquire the information about priority.

The MCPTT server 95A transmits a 200 OK message to the UE 10A (S2426). The MCPTT server 95A includes information about priority in the 200 OK message.

The UE 10A receives the 200 OK message. The UE 10A may detect the information about priority and manage the information about priority.

The UE 10A transmits a check response to the MCPTT server 95A (S2428), the MCPTT server 95A transmits a check response to the MCPTT server 95B (S2430), the MCPTT server 95B transmits a check response to the UE 10B (S2432), the MCPTT server 95A transmits a talk burst check to the UE 10A (S2434), and the MCPTT server 95A transmits a talk burst receive to the UE 10B via the MCPTT server 95B (S2436). Here, the procedure from S2428 to S2436 is similar to the procedure of the on-demand session establishment procedure 6 described in the second embodiment, so that detailed description thereof will be omitted.

With the aforementioned procedure, the UE 10A is able to stop the transmission in the session with the UE 10B, which is indicated by the session identifier 1, and establish the session indicated by the session identifier 2 to start transmission. The UE 10A is able to acquire information about usable priority by the session establishment procedure.

As above, the embodiments and the modified examples of the invention have been described in detail with reference to the drawings, but specific configurations are not limited to the embodiments, and a design and the like which are not departed from the spirit of the invention are also included in the scope of the claims.

A program which runs in each of the apparatuses in each of the embodiments is a program that controls a CPU and the like (a program that causes a computer to function) such that the functions in the aforementioned embodiments are realized. The pieces of information handled by the apparatuses are temporarily accumulated in a temporary storage apparatus (for example, RAM) during the processing thereof, and then stored in various storage apparatuses such as ROMs and HDDs, and read, corrected, and written by the CPU as necessary.

A recording medium that stores the program therein may be any of a semiconductor medium. (for example, a ROM, a nonvolatile memory card, or the like), an optical recording medium and an optical magnetic recording medium (for example, a DVD (Digital Versatile Disc), an MO (Magneto Optical Disc), an MD (Mini Disc), a CD (Compact Disc), a BD, or the like), a magnetic recording medium (for example, a magnetic tape, a flexible disc, or the like), and the like. Moreover, there is also a case where, by executing the loaded program, not only the functions of the aforementioned embodiments are realized, but also by performing processing in cooperation with an operating system, other application programs, or the like on the basis of an instruction of the program, the functions of the invention are realized.

When being distributed in the market, the program is able to be stored in a portable recording medium and distributed or be transferred to a server computer connected through a network such as the Internet. In this case, a storage apparatus of the server computer is, of course, included in the invention.

A part or all of the apparatuses in the aforementioned embodiments may be realized as an LSI (Large Scale Integration) which is a typical integrated circuit. Each functional block of the apparatuses may be individually formed into a chip, or a part or all thereof may be integrated and formed into a chip. Further, a method for making into an integrated circuit is not limited to the LSI and a dedicated circuit or a versatile processor may be used for realization. Further, in a case where a technique for making into an integrated circuit in place of the LSI appears with advance of a semiconductor technique, an integrated circuit by the technique is, of course, able to be used.

Though the LTE and the WLAN (for example, IEEE802.11a/b/n or the like) have been described as an example of the radio access network in the aforementioned embodiments, a connection may be made by WiMAX instead of the WLAN.

1. A first terminal apparatus configured to:
transmit, to a second server apparatus, a service authentication request message of a communication service in which user data is transmitted or received on a basis of an arbitration function of a first server apparatus,
the arbitration function being a function for deciding which terminal apparatus of a plurality of terminal apparatuses is to be permitted, at a certain time point, to perform data transmission,
receive, from the second server apparatus, a response message that is a response to the service authentication request message and includes at least information for permitting service authentication and priority,
transmit, to the first server apparatus, a session establishment request message including at least the priority,
receive, from the first server apparatus, a response message that is a response to the session establishment request message,
establish, upon reception of the response message, a session of the communication service with a second terminal apparatus,
receive, from the first server apparatus, user data transmitted by the second terminal apparatus that is permitted by the first server apparatus to perform data transmission for a certain fixed time, and
transmit, to the first server apparatus, user data that is to be transmitted to the second terminal apparatus on a basis of the priority during the fixed time.

2. The first terminal apparatus according to claim 1, wherein
the first terminal apparatus transmits the service authentication request message with at least the priority requested by the first terminal apparatus included therein.

3. A first terminal apparatus configured to:
transmit a session establishment request message to a first server apparatus,
receive, from the first server apparatus, a response message that is a response to the session establishment request message, which includes at least priority,
establish, upon reception of the response message, a session with a second terminal apparatus,
the session being a session in which user data is transmitted or received on a basis of an arbitration function of the first server apparatus,
receive, from the first server apparatus, user data transmitted by the second terminal apparatus that is permitted by the first server apparatus to perform data transmission for a certain fixed time, and
transmit, to the first server apparatus, user data that is to be transmitted to the second terminal apparatus on a basis of the priority during the fixed time.

4. The first terminal apparatus according to claim 3, wherein
the first terminal apparatus transmits the session establishment request message with at least the priority requested by the first terminal apparatus included therein.

5. The first terminal apparatus according to claim 1, wherein
the first terminal apparatus
transmits a request message requesting the first server apparatus to transmit user data,
receive a response message that is a response to the request message and that is transmitted by the first server apparatus, and
transmit, to the first server apparatus, the user data that is to be transmitted to the second terminal apparatus on a basis of the response message.

6. The first terminal apparatus according to claim 5, wherein the first terminal apparatus transmits the request message with at least the priority included therein.

7. A server apparatus configured to:
receive, from a first terminal apparatus, a session establishment request message,
transmit, to the first terminal apparatus, a response message that is a response to the session establishment request message, which includes at least priority,
establish, upon transmission of the response message, a session of a communication service, in which user data is transmitted or received on a basis of an arbitration function, between the first terminal apparatus and a second terminal apparatus,
the arbitration function being a function for deciding which terminal apparatus of a plurality of terminal apparatuses is to be permitted, at a certain time point, to perform data transmission,
permit the second terminal apparatus to perform data transmission for a fixed time on a basis of the arbitration function,
receive user data transmitted by the second terminal apparatus on a basis of the permission,
transmit the user data to the first terminal apparatus,
receive user data transmitted by the first terminal apparatus on a basis of the priority during the fixed time, and
transmit the user data to the second terminal apparatus.

8. A server apparatus configured to:
receive, from a first terminal apparatus, a session establishment request message which includes at least priority is received,
transmit, to the first terminal apparatus, a response message that is a response to the session establishment request message,
establish, upon transmission of the response message, a session of a communication service in which user data is transmitted or received on a basis of an arbitration function between the first terminal apparatus and a second terminal apparatus,
the arbitration function being a function for deciding which terminal apparatus of a plurality of terminal apparatuses is to be permitted, at a certain time point, to perform data transmission,
permit the second terminal apparatus to perform data transmission for a fixed time on a basis of the arbitration function,
receive user data transmitted by the second terminal apparatus on a basis of the permission,
transmit the user data to the first terminal apparatus,
receive user data transmitted by the first terminal apparatus on a basis of the priority during the fixed time, and
transmit the user data to the second terminal apparatus.

9. The server apparatus according to claim 7, wherein
the server apparatus
receives, from the first terminal apparatus, a request message requesting transmission of user data,
transmits, to the first terminal apparatus, a response message that is a response to the request message, and
receives the user data transmitted by the first terminal apparatus on a basis of the response message.

10. The server apparatus according to claim 9, wherein
the server apparatus
receives the request message with at least the priority included therein, and
receives the user data transmitted by the first terminal apparatus on a basis of the priority.

11. A control method of a first terminal apparatus, comprising the steps of:
transmitting, to a second server apparatus, a service authentication request message of a communication service in which user data is transmitted or received on a basis of an arbitration function of a first server apparatus,
the arbitration function being a function for deciding which terminal apparatus of a plurality of terminal apparatuses is to be permitted, at a certain time point, to perform data transmission;
receiving, from the second server apparatus, a response message that is a response to the service authentication request message and includes at least information for permitting service authentication and priority;
transmitting, to the first server apparatus, a session establishment request message including at least the priority;
receiving, from the first server apparatus, a response message that is a response to the session establishment request message;
establishing, upon reception of the response message, a session of the communication service with a second terminal apparatus;
receiving, from the first server apparatus, user data transmitted by the second terminal apparatus that is permitted by the first server apparatus to perform data transmission for a certain fixed time; and
transmitting, to the first server apparatus, on a basis of the priority during the fixed time, user data which is to be transmitted to the second terminal apparatus.

12. The control method according to claim 11, comprising the step of
including at least the priority requested by the first terminal apparatus in the service authentication request message.

13. A control method of a first terminal apparatus, comprising the steps of:
transmitting a session establishment request message to a first server apparatus;
receiving, from the first server apparatus, a response message that is a response to the session establishment request message, which includes at least priority;
establishing, upon reception of the response message, a session with a second terminal apparatus,
the session being a session in which user data is transmitted or received on a basis of an arbitration function of the first server apparatus;
receiving, from the first server apparatus, user data transmitted by the second terminal apparatus that is permitted by the first server apparatus to perform data transmission for a certain fixed time; and
transmitting, to the first server apparatus, on a basis of the priority during the fixed time, user data which is to be transmitted to the second terminal apparatus.

14. The control method according to claim 13, comprising the step of
including at least the priority requested by the first terminal apparatus in the session establishment request message.

15. The control method according to claim 11, comprising the steps of:
transmitting a request message requesting the first server apparatus to transmit user data;
receiving a response message that is a response to the request message and that is transmitted by the first server apparatus; and
transmitting, to the first server apparatus, on a basis of the response message, the user data which is to be transmitted to the second terminal apparatus.

16. The control method according to claim 15, comprising the step of
including at least the priority in the request message.

17. A control method of a server apparatus, comprising the steps of:
receiving a session establishment request message from a first terminal apparatus;
transmitting, to the first terminal apparatus, a response message that is a response to the session establishment request message, which includes at least priority;
establishing, upon transmission of the response message, a session of a communication service, in which user data is transmitted or received on a basis of an arbitration function, between the first terminal apparatus and a second terminal apparatus,
the arbitration function being a function for deciding which terminal apparatus of a plurality of terminal apparatuses is to be permitted, at a certain time point, to perform data transmission;
permitting, on a basis of the arbitration function, the second terminal apparatus to perform data transmission for a fixed time;
receiving, on a basis of the permission, user data which is transmitted by the second terminal apparatus;
transmitting the user data to the first terminal apparatus;
receiving, on a basis of the priority during the fixed time, user data which is transmitted by the first terminal apparatus; and
transmitting the user data to the second terminal apparatus.

18. A control method of a server apparatus, comprising the steps of:
receiving, from a first terminal apparatus, a session establishment request message, which includes at least priority;
transmitting, to the first terminal apparatus, a response message that is a response to the session establishment request message;
establishing, upon transmission of the response message, a session of a communication service, in which user data is transmitted or received on a basis of an arbitration function, between the first terminal apparatus and a second terminal apparatus,
the arbitration function being a function for deciding which terminal apparatus of a plurality of terminal apparatuses is to be permitted, at a certain time point, to perform data transmission;
permitting, on a basis of the arbitration function, the second terminal apparatus to perform data transmission for a fixed time;
receiving, on a basis of the permission, user data which is transmitted by the second terminal apparatus;
transmitting the user data to the first terminal apparatus;
receiving, on a basis of the priority during the fixed time, user data which is transmitted by the first terminal apparatus; and
transmitting the user data to the second terminal apparatus.

19. The control method according to claim 17, comprising the steps of:
receiving, from the first terminal apparatus, a request message requesting transmission of user data;
transmitting, to the first terminal apparatus, a response message that is a response to the request message; and
receiving, on a basis of the response message, the user data which is transmitted by the first terminal apparatus.

20. The control method according to claim 19, comprising the steps of:
receiving the request message including at least the priority and acquiring the priority, and
executing, on a basis of the priority, reception of the user data that is transmitted by the first terminal apparatus.

21. The first terminal apparatus according to claim 3, wherein the first terminal apparatus
transmits a request message requesting the first server apparatus to transmit user data,
receive a response message that is a response to the request message and that is transmitted by the first server apparatus, and
transmit, to the first server apparatus, the user data that is to be transmitted to the second terminal apparatus on a basis of the response message.

22. The server apparatus according to claim 8, wherein
the server apparatus
receives, from the first terminal apparatus, a request message requesting transmission of user data,
transmits, to the first terminal apparatus, a response message that is a response to the request message, and
receives the user data transmitted by the first terminal apparatus on a basis of the response message.

23. The control method according to claim 13, comprising the steps of:
transmitting a request message requesting the first server apparatus to transmit user data;
receiving a response message that is a response to the request message and that is transmitted by the first server apparatus; and
transmitting, to the first server apparatus, on a basis of the response message, the user data which is to be transmitted to the second terminal apparatus.

24. The control method according to claim 18, comprising the steps of:
receiving, from the first terminal apparatus, a request message requesting transmission of user data;
transmitting, to the first terminal apparatus, a response message that is a response to the request message; and
receiving, on a basis of the response message, the user data which is transmitted by the first terminal apparatus.
